(19) United States
(12) Patent Application Publication
(10) Pub. No.: US 2025/0361445 A1
(43) Pub. Date: Nov. 27, 2025

(54) POLYMERISABLE LIQUID CRYSTAL MEDIUM AND POLYMERISED LIQUID CRYSTAL FILM

(71) Applicant: MERCK PATENT GmbH, Darmstadt (DE)

(72) Inventors: Jack BRADFORD, Feltham (GB); Tara PERRETT, Feltham (GB); Matthew CREALLY, Feltham (GB); Ian GARDINER, Feltham (GB)

(73) Assignee: MERCK PATENT GmbH, Darmstadt (DE)

(21) Appl. No.: 18/872,152

(22) PCT Filed: Jun. 7, 2023
(86) PCT No.: PCT/EP2023/065160

§ 371 Date: Dec. 5, 2024

(30) Foreign Application Priority Data
Jun. 10, 2022 (EP) 22178343

(51) Int. Cl. C09K 19/58; C09K 19/04; C09K 19/06; C09K 19/12; C09K 19/20

(52) U.S. Cl. CPC C09K 19/586; C09K 19/066; C09K 19/12; C09K 19/20; C09K 2019/0448; C09K 2019/122; C09K 2019/2035; C09K 2019/2078

(57) ABSTRACT

A polymerisable LC medium comprising one or more di- or multireactive mesogenic compounds, one or more chiral compounds with (s)-configuration, and one or more chiral compounds with (R)-configuration, wherein at least one of the chiral compounds comprises an photoisomerisable group. Further, a method for its preparation, a polymer film obtainable from a corresponding polymerisable LC medium, and a method of preparation of such polymer film. The polymer films may be used for purposes such as, for example, adjusting optical properties of a liquid crystal display (LCD), improving light utilization efficiency, ensuring anti-reflectivity and visibility in an organic light emitting device (OLED), or for AV/VR. Further, the use of such polymer film and said polymerisable LC medium for optical, electro-optical, decorative or security applications and for corresponding devices.

### TECHNICAL FIELD OF THE INVENTION

The invention relates to a polymerisable LC medium comprising one or more di- or multireactive mesogenic compounds, one or more chiral compounds with (s)-configuration, one or more chiral compounds with (R)-configuration, wherein at least one of the chiral compounds comprises an photoisomerisable group. Furthermore, the present invention relates also to a method for its preparation, a polymer film obtainable from a corresponding polymerisable LC medium, to a method of preparation of such polymer film. These polymer films may be used for purposes such as, for example, adjusting optical properties of a liquid crystal display (LCD), improving light utilization efficiency, or ensuring anti-reflectivity and visibility in an organic light emitting device (OLED), or even for AVNR. Accordingly, the invention relates further to the use of such polymer film and said polymerisable LC medium for optical, electro-optical, decorative or security applications and to corresponding devices as such.

### BACKGROUND AND PRIOR ART

OLED displays are constructed with a metallic cathode which has high reflectivity and acts like a mirror. It is important that the viewer only sees the light emitted by the OLED and not incident light reflected off the display. To achieve this an anti-reflection layer is required in the display.

Typically a circular polariser will be employed to optically isolate incident light and remove reflection. The circular polariser consists of a linear polariser combined with a quarter wave retarder. To prevent any reflected light leaving the system the quarter wave plate (QWP) must have an optical retardation that matches exactly one quarter of the wavelength of the incident light. Ideally the QWP should be achromatic, so it performs equally well for all visible wavelengths.

Standard transparent materials have positive optical dispersion, i.e., the refractive index reduces with increasing wavelength. An RM film with standard optical dispersion produces a QWP which converts linearly polarised input light to perfectly circular polarised light, and vice versa, for only a single wavelength. All other wavelengths will be converted to a nonideal elliptical polarisation state, and a portion of this light will not be absorbed by the polariser after reflection and be transmitted to the viewer. This results in poor anti-reflection and a screen which may look purple rather than black.

To produce an achromatic QWP the retarder must have reverse (also known as negative) optical dispersion, i.e., the refractive index increases with increasing wavelength.

One way to make a reverse optical dispersion QWP is to combine a half wave plate (HWP) with positive optical dispersion with a QWP with positive optical dispersion. These two retarders must be laminated with their directors perpendicular to each other. The disadvantage of this solution is increased process cost due to having to coat two separate films and then laminate them together. There is also reduced yield due to the lamination cutting process.

Optical films based on polymerisable liquid crystal materials typically exhibit a wavelength dependent retardation. In this regard, three main kinds of optical behaviour are known:
i) “Normal” or “Positive” optical dispersion, such as for example described in EP 0 940 707 B1
ii) “Reverse” or “Negative” optical dispersion, such as, for example described in WO 2016/020035 A1, and
iii) “Flat” optical dispersion, such as for example described in WO 2009/058396 A1.

For example, polymerisable liquid crystal materials with flat or negative dispersion can be produced by adding at least one component having an ordinary refractive index (nₒ) higher than the extraordinary refractive index (nₑ) to the formulation. For this purpose, highly conjugated substituents are usually required in the orthogonal position with respect to the long-axis of the molecules. These materials absorb a part of the UV dose when curing optical films which results in poor degree of cure and poor thermal durability of cured films. Besides the molecular blocks can easily oxidise under high temperatures in the presence of oxygen. The same applies to high birefringent formulations containing highly conjugated reactive mesogens which reduce the thermal durability of cured films and are typically prone to yellowing.

Prior art also discloses polymerisable compounds having an H-shape or a T-shape for use in birefringent polymer films with negative optical dispersion. For example, WO 2008/119427 A1 describes a birefringent polymer film with negative optical dispersion, which is obtainable from a polymerisable LC medium comprising as negative dispersion component compounds having an H-shape.

Suitable compounds having a T-shape and corresponding birefringent polymer films with negative optical dispersion are disclosed e.g. in US 2015175564, WO 17079867 A1, WO16104317 A, US 2015277007 A1, or WO 16171041 A1 and in particular include compounds represented by formulae 1 to 5 of US 2015175564 A1, compounds represented by formulae (I-1) to (I-5), (I-8), (I-14), (I-16) to (I-36), (I-41), (I-54) to (I-65), (I-75) to (I-80), (I-82), (I-83), (I-86) to (I-97) and (I-121) to (I-125) of WO 17/079867 A1, compounds represented by formulae (A12-16) to (A12-18), (A14-1) to (A14-3) and (A141-1) to (A143-2) of WO 16104317 A1, compounds represented by formulae (2-A) to (2-D), (3-A) to (3-D), (4-A) to (4-D), (5-A) to (5-D), (7-A) to (7-D), (8-A) to (8-D), (9-A) to (9-D), (11-B) to (11-D), (12-b) to (12-D), (13-B) to (13-D), (22-B) to (22-D), (25-B) to (25-D), (40-A) to (40-D), (41-A) to (41-D), (42-A) to (42-D), (43-A) to (43-D), (44-A) to (44-D), (50-A) to (50-D), (52-A) to (52-D), (54-A) to (54-D), (55-A) to (55-D), or (56-A) to (56-D) of US 2015/0277007 A1, compounds represented by formulae (A) to (E) of WO 16171041 A1,

However, the bulky nature of the negative dispersion compounds according to the prior art are typically hard to align or give formulations with a narrow process window for annealing temperature, which is not convenient for mass production. Also, the polymer film is normally weaker and less resistant to heat. However, the main disadvantage is that the cost of synthesis of the T-shape and H-shape materials is much higher than that of standard LC molecules due the increased number of synthesis steps. A cheaper alternative to the typical reverse dispersion films would allow competitiveness in a wider range of markets particularly for OLED TV.

In this regard, US 2016187554 A1 suggests an optical film whereby through control of an alignment state of a liquid crystal compound in a liquid crystal layer, the liquid crystal layer exhibits so-called reverse-wavelength dispersion while forming a single thin layer. These films may be used for purposes such as, for example, adjusting optical properties of a liquid crystal display (LCD), improving light utilization efficiency, or ensuring anti-reflectivity and visibility in an organic light emitting device (OLED). Further, the films as described above may be used to generate a stereoscopic image, or to improve quality of the stereoscopic image.

However, there is still a need for novel and improved polymerisable liquid crystal materials or resulting polymer films which do not exhibit the drawbacks of prior art materials or if they do so, only exhibit them to a lesser extent.

The polymerisable LC media comprising them, which are used for film preparation, should exhibit good thermal properties, in particular a modest melting point, a good solubility in the LC host and in organic solvents, and a reasonable extrapolated clearing point, and should further exhibit excellent optical properties.

Advantageously, said polymerisable LC material should preferably be applicable for the preparation of different polymer films, and should, in particular at the same time,
show a favourable adhesion to a substrate,
be highly transparent to VIS-light,
exhibit an reduced yellow colouration over time (yellowing),
exhibit a high birefringence in order to reduce the film thickness,
show a favourable high temperature stability or durability, and, in addition,
the polymer films should be produced cheaply by compatible, commonly known, methods for mass production.

Other aims of the present invention are immediately evident to the person skilled in the art from the following detailed description.

Surprisingly, the inventors of the present invention have found that one or more, preferably all of the above requirements can be fulfilled, preferably at the same time, by using a polymerisable LC medium as disclosed and claimed hereinafter.

### SUMMARY OF THE INVENTION

The invention relates to a polymerisable LC medium comprising one or more di- or multireactive mesogenic compounds, one or more chiral compounds with (S)-configuration, one or more chiral compounds with (R)-configuration, wherein at least one of the chiral compounds comprises an photoisomerisable group.

The invention further relates to a method of production for a polymerisable LC medium as described above and below.

The invention further relates to the use of a polymerisable LC medium as described above and below in optical, electronic and electro optical components and devices, preferably in optical films, retarders or compensators having flat optical dispersion.

The invention especially relates to a method of production of a polymer film as described above and below.

The invention further relates to a birefringent polymer film being obtainable or obtained by polymerising a polymerisable LC medium as described above and below, preferably in its LC phase in an oriented state in form of a thin film.

The invention especially relates to a polymer film as described above and below, which is an achromatic QWP.

The invention especially further to the use of a polymer film as described above and below, in an optical component.

The invention further relates to an optical, electronic or electro optical component or device as such, comprising a polymerisable LC medium or a polymer film as described above and below.

Said devices include, without limitation, electro optical displays, such as OLED and LCDs, non-linear optic (NLO) devices, optical information storage devices, electronic devices, electroluminescent displays, organic photovoltaic (OPV) devices, lighting devices, sensor devices, electro photographic recording devices, organic memory devices or devices for ARNR applications.

### Terms and Definitions

As used herein, the term “polymer” will be understood to mean a molecule that encompasses a backbone of one or more distinct types of repeating units (the smallest constitutional unit of the molecule) and is inclusive of the commonly known terms “oligomer”, “copolymer”, “homopolymer” and the like. Further, it will be understood that the term polymer is inclusive of, in addition to the polymer itself, residues from initiators, catalysts, and other elements attendant to the synthesis of such a polymer, where such residues are understood as not being covalently incorporated thereto. Further, such residues and other elements, while normally removed during post polymerisation purification processes, are typically mixed or co-mingled with the polymer such that they generally remain with the polymer when it is transferred between vessels or between solvents or dispersion media.

The term “(meth)acrylic polymer” as used in the present invention includes a polymer obtained from acrylic monomers, a polymer obtainable from methacrylic monomers, and a corresponding co-polymer obtainable from mixtures of such monomers.

The term “polymerisation” means the chemical process to form a polymer by bonding together multiple polymerisable groups or polymer precursors (polymerisable compounds) containing such polymerisable groups.

The terms “film” and “layer” include rigid or flexible, self-supporting or freestanding films with mechanical stability, as well as coatings or layers on a supporting substrate or between two substrates.

The term “liquid crystal or mesogenic compound” means a compound comprising one or more calamitic (rod- or board/lath-shaped) or discotic (disk-shaped) mesogenic groups. The term “mesogenic group” means a group with the ability to induce liquid crystal (LC) phase behaviour. The compounds comprising mesogenic groups do not necessarily have to exhibit an LC phase themselves. It is also possible that they show LC phase behaviour only in mixtures with other compounds, or when the mesogenic compounds or materials, or the mixtures thereof, are polymerised. For the sake of simplicity, the term “liquid crystal” is used hereinafter for both mesogenic and LC materials. For an overview of definitions see C. Tschierske, G. Pelzl and S. Diele, Angew. Chem. 2004, 116, 6340-6368.

A calamitic mesogenic group is usually comprising a mesogenic core consisting of one or more aromatic or non-aromatic cyclic groups connected to each other directly or via linkage groups, optionally comprising terminal groups attached to the ends of the mesogenic core, and optionally comprising one or more lateral groups attached to the long side of the mesogenic core, wherein these terminal and lateral groups are usually selected e.g. from carbyl or hydrocarbyl groups, polar groups like halogen, nitro, hydroxy, etc., or polymerisable groups.

The term “reactive mesogen” (RM) means a polymerisable mesogenic or liquid crystal compound.

Polymerisable compounds with one polymerisable group are also referred to as “monoreactive” compounds, compounds with two polymerisable groups as “direactive” compounds, and compounds with more than two polymerisable groups as “multireactive” compounds. Compounds without a polymerisable group are also referred to as “non-reactive” compounds.

The term “non-mesogenic compound or material” means a compound or material that does not contain a mesogenic group as defined above.

Visible light is electromagnetic radiation that has wavelength in a range from about 400 nm to about 740 nm. Ultraviolet (UV) light is electromagnetic radiation with a wavelength in a range from about 200 nm to about 450 nm.

According to the present application, the term “linearly polarised light” means light, which is at least partially linearly polarized. Preferably, the aligning light is linearly polarized with a degree of polarization of more than 5:1. Wavelengths, intensity and energy of the linearly polarised light are chosen depending on the photosensitivity of the photoalignable material. Typically, the wavelengths are in the UV-A, UV-B and/or UV-C range or in the visible range. Preferably, the linearly polarised light comprises light of wavelengths less than 450 nm, more preferably less than 420 nm at the same time the linearly polarised light preferably comprises light of wavelengths longer than 280 nm, preferably more than 320 nm, more preferably over 350 nm.

The Irradiance (Ee) or radiation power is defined as the power of electromagnetic radiation (do) per unit area (dA) incident on a surface:

$${E}_{e} = d θ / dA .$$

The radiant exposure or radiation dose (He), is as the irradiance or radiation power (Ee) per time (t):

$${H}_{e} = {E}_{e} \cdot t .$$

All temperatures, such as, for example, the melting point T(C,N) or T(C,S), the transition from the smectic (S) to the nematic (N) phase T(S,N) and the clearing point T(N,I) of the liquid crystals, are quoted in degrees Celsius. All temperature differences are quoted in differential degrees.

The term “clearing point” means the temperature at which the transition between the mesophase with the highest temperature range and the isotropic phase occurs.

On the molecular level, the birefringence of a liquid crystal depends on the anisotropy of the polarizability (Δα=α_{┐┐}−α⊥). “Polarizability” means the ease with which the electron distribution in the atom or molecule can be distorted. The polarizability increases with greater number of electrons and a more diffuse electron cloud. The polarizability can be calculated using a method described in e.g. Jap. J. Appl. Phys. 42, (2003) p. 3463.

The “optical retardation” at a given wavelength R(λ) (in nm) of a layer of liquid crystalline or birefringent material is defined as the product of birefringence at that wavelength Δn(λ) and layer thickness d (in nm) according to the equation

$$R ( λ ) = Δ n ( λ ) \cdot d$$

The optical retardation R represents the difference in the optical path lengths in nanometres travelled by S-polarised and P-polarised light whilst passing through the birefringent material. “On-axis” retardation means the retardation at normal incidence to the sample surface.

The term “negative (optical) dispersion” refers to a birefringent or liquid crystalline material or layer that exhibits reverse birefringence dispersion where the magnitude of the birefringence (Δn) increases with increasing wavelength (λ). i.e., |Δn(450)|<|Δn(550), or Δn(450)/Δn(550)<1, where Δn(450) and Δn(550) are the birefringence of the material measured at wavelengths of 450 nm and 550 nm respectively. In contrast, positive (optical) dispersion” means a material or layer having |Δn(450)|>|Δn(550)| or Δn(450)/Δn(550)>1. See also for example A. Uchiyama, T. Yatabe “Control of Wavelength Dispersion of Birefringence for Oriented Copolycarbonate Films Containing Positive and Negative Birefringent Units”. J. Appl. Phys. Vol. 42 pp 6941-6945 (2003). “Flat (optical) dispersion” means a material or layer having |Δn(450)|>|Δn(550)| or Δn(450)/Δn(550)≈1.

Since the optical retardation at a given wavelength is defined as the product of birefringence and layer thickness as described above [R(λ)=Δn(λ)·d], the optical dispersion can be expressed either as the “birefringence dispersion” by the ratio Δn(450)/Δn(550), or as “retardation dispersion” by the ratio R(450)/R(550), wherein R(450) and R(550) are the retardation of the material measured at wavelengths of 450 nm and 550 nm respectively. Since the layer thickness d does not change with the wavelength, R(450)/R(550) is equal to Δn(450)/Δn(550). Thus, a material or layer with negative or reverse dispersion has R(450)/R(550)<1 or |R(450)|<| R(550)|, a material or layer with positive or normal dispersion has R(450)/R(550)>1 or | R(450)|>| R(550)|, and a material or layer with flat dispersion has R(450)/R(550)=1 or |R(450)|≈| R(550)|.

In the present invention, unless stated otherwise “optical dispersion” means the retardation dispersion i.e., the ratio R(450)/R(550).

The term “high dispersion” means that the absolute value of the dispersion shows a large deviation from 1, whereas the term “low dispersion” means that the absolute value of the dispersion shows a small deviation from 1. Thus, for example, “high negative dispersion” means that the dispersion value is significantly smaller than 1, and “low negative dispersion” means that the dispersion value is only slightly smaller than 1.

The retardation (R(λ)) of a material can be measured using a spectroscopic ellipsometer, for example the M2000 spectroscopic ellipsometer manufactured by J. A. Woollam Co. This instrument can measure the optical retardance in nanometres of a birefringent sample e.g., Quartz over a range of wavelengths typically, 370 nm to 2000 nm. From this data it is possible to calculate the dispersion (R(450)/R(550) or Δn(450)/Δn(550)) of a material.

A method for carrying out these measurements was presented at the National Physics Laboratory (London, UK) by N. Singh in October 2006 and entitled “Spectroscopic Ellipsometry, Part1—Theory and Fundamentals, Part 2—Practical Examples and Part 3—measurements”. In accordance with the measurement procedures described Retardation Measurement (RetMeas) Manual (2002) and Guide to WVASE (2002) (Woollam Variable Angle Spectroscopic Ellipsometer) published by J. A. Woollam Co. Inc (Lincoln, NE, USA). Unless stated otherwise, this method is used to determine the retardation of the materials, films and devices described in this invention.

The birefringence Δn is defined as follows

$$Δ n = {n}_{e} - {n}_{0}$$

wherein nₑ is the extraordinary refractive index and nₒ is the ordinary refractive index, and the effective average refractive index n_{av.} is given by the following equation:

$${n}_{av .} = {( ( 2 {n}_{0}^{2} + {n}_{e}^{2} ) / 3 )}^{1 / 2}$$

The average refractive index n_{av.} and the ordinary refractive index nₒ can be measured using an Abbe refractometer. An can then be calculated from the above equations.

A polymerisable LC medium in accordance with the present invention can be prepared, for example, by doping the medium with chiral compounds having a high twisting power. The pitch p of the induced cholesteric helix is then given by the concentration c and the helical twisting power HTP of the chiral compound in accordance with the following equation:

$$p = {( HTP c )}^{- 1}$$

The total HTP of chiral compounds having the same configuration (HTPₜₒₜₐₗ) holds then approximately the following equation:

$${HTP}_{total} = {\sum }_{i} {c}_{i} {HTP}_{i}$$

wherein cᵢ is the concentration of each individual chiral compound and HTPᵢ is the helical twisting power of each individual chiral compound.

The HTP of all chiral compounds within a mixture of different configurations (IHTP_{Δ}I) holds then approximately the following equation:

$$\vert {HTP}_{Δ} \vert = ( {\sum }_{s} {c}_{s} {HTP}_{s} ) - ( ( {\sum }_{r} {c}_{r} {HTP}_{r} )$$

wherein cₛ is the concentration of each individual chiral compound with S configuration, HTPₛ is the helical twisting power of each individual chiral compound having S configuration and wherein cᵣ is the concentration of each individual chiral compound with R configuration and HTP_{R} is the helical twisting power of each individual chiral compound having R configuration.

A photoreactive group (also referred to as photoisomerisable group) according to the present invention is a functional group of a molecule that causes a change of the geometry of the molecule, i.e. isomerisation, either by bond rotation, skeletal rearrangement or atom- or group-transfer, or by dimerization, upon irradiation with light of a suitable wavelength that can be absorbed by the molecule (photoisomerisation).

A photoreactive compound (also referred to as photoisomerisable compound) according to the present invention is a compound comprising one or more photoreactive groups (or photoisomerisable groups).

Examples of photoreactive groups are —C═C— double bonds and azo groups (—N═N—). Examples of molecular structures and sub-structures comprising such photoreactive groups are stilbene, (1,2-difluoro-2-phenyl-vinyl)-benzene, cinnamate, 4-phenylbut-3-en-2-one, chalcone, coumarin, chromone, pentalenone and azobenzene.

The term “director” is known in prior art and means the preferred orientation direction of the long molecular axes (in case of calamitic compounds) or short molecular axes (in case of discotic compounds) of the liquid-crystalline or RM molecules. In case of uniaxial ordering of such anisotropic molecules, the director is the axis of anisotropy.

All physical properties have been and are determined according to “Merck Liquid Crystals, Physical Properties of Liquid Crystals”, Status November 1997, Merck KGaA, Germany and are given for a temperature of 20° C., unless explicitly stated otherwise. The optical anisotropy (Δn) is determined at a wavelength of 589.3 nm

In case of doubt the definitions as given in C. Tschierske, G. Pelzl and S. Diele, Angew. Chem. 2004, 116, 6340-6368 shall apply.

Unless explicitly stated otherwise in the given generic formulae, the following terms have the following meanings:

“Carbyl group” denotes a mono- or polyvalent organic group containing at least one carbon atom which either contains no further atoms (such as, for example, —C≡C—) or optionally contains one or more further atoms, such as, for example, N, O, S, P, Si, Se, As, Te or Ge (for example carbonyl, etc.). “Hydrocarbyl group” denotes a carbyl group, which additionally contains one or more H atoms and optionally one or more heteroatoms, such as, for example, N, O, S, P, Si, Se, As, Te or Ge.

A carbyl or hydrocarbyl group can be a saturated or unsaturated group. Unsaturated groups are, for example, aryl, alkenyl, or alkynyl groups. A carbyl or hydrocarbyl group having more than 3 C atoms can be straight chain, branched and/or cyclic and may contain spiro links or condensed rings.

Preferred carbyl and hydrocarbyl groups are optionally substituted alkyl, alkenyl, alkinyl, alkoxy, alkylcarbonyl, alkoxycarbonyl, alkylcarbonyloxy and alkoxycarbonyloxy having 1 to 40, preferably 1 to 25, particularly preferably 1 to 18 C atoms, optionally substituted aryl or aryloxy having 6 to 40, preferably 6 to 25 C atoms, or optionally substituted alkylaryl, arylalkyl, alkylaryloxy, arylalkyloxy, arylcarbonyl, aryloxycarbonyl, arylcarbonyloxy and aryloxycarbonyloxy having 6 to 40, preferably 6 to 25 C atoms.

Further preferred carbyl and hydrocarbyl groups are C₁-C₄₀ alkyl, C₂-C₄₀ alkenyl, C₂-C₄₀ alkinyl, C₃-C₄₀ allyl, C₄-C₄₀ alkyldienyl, C₄-C₄₀ polyenyl, C₆-C₄₀ aryl, C₆-C₄₀ alkylaryl, C₆-C₄₀ arylalkyl, C₆-C₄₀ alkylaryloxy, C₆-C₄₀ arylalkyloxy, C₂-C₄₀ heteroaryl, C₄-C₄₀ cycloalkyl, C₄-C₄₀ cycloalkenyl, etc. Preference is given to C₁-C₂₂ alkyl, C₂-C₂₂ alkenyl, C₂-C₂₂ alkinyl, C₃-C₂₂ allyl, C₄-C₂₂ alkyldienyl, C₆-C₁₂ aryl, C₆-C₂₀ arylalkyl, and C₂-C₂₀ heteroaryl.

Further preferred carbyl and hydrocarbyl groups are straight-chain, branched or cyclic alkyl radicals having 1 to 40, preferably 1 to 25 C atoms, more preferably 1 to 12 C atoms, which are unsubstituted or mono- or polysubstituted by F, Cl, Br, I or CN and in which one or more non-adjacent CH₂ groups may each be replaced, independently of one another, by —C(R^{x})═C(R^{x})—, —C≡C—, —N(R^{x})—, —O—, —S—, —CO—, —CO—O—, —O—CO—, —O—CO—O— in such a way that O and/or S atoms are not linked directly to one another.

Above, R^{x} preferably denotes H, halogen, a straight-chain, branched or cyclic alkyl chain having 1 to 25 C atoms, in which, in addition, one or more non-adjacent C atoms may be replaced by —O—, —S—, —CO—, —CO—O—, —O—CO—, —O—CO—O—, and in which one or more H atoms may be replaced by fluorine, an optionally substituted aryl or aryloxy group having 6 to 40 C atoms or an optionally substituted heteroaryl or heteroaryloxy group having 2 to 40 C atoms.

Preferred alkyl groups are, for example, methyl, ethyl, n-propyl, isopropyl, n-butyl, isobutyl, s-butyl, t-butyl, 2-methylbutyl, n-pentyl, s-pentyl, n-hexyl, 2-ethylhexyl, n-heptyl, n-octyl, n-nonyl, n-decyl, n-undecyl, n-dodecyl, dodecanyl, trifluoromethyl, perfluoro-n-butyl, 2,2,2-trifluoroethyl, perfluorooctyl, perfluorohexyl, etc.

Preferred alkenyl groups are, for example, ethenyl, propenyl, butenyl, pentenyl, cyclopentenyl, hexenyl, cyclohexenyl, heptenyl, cycloheptenyl, octenyl, cyclooctenyl, etc.

Preferred alkinyl groups are, for example, ethynyl, propynyl, butynyl, pentynyl, hexynyl, octynyl, etc.

Preferred alkoxy groups are, for example, methoxy, ethoxy, 2-methoxyethoxy, n-propoxy, i-propoxy, n-butoxy, i-butoxy, s-butoxy, t-butoxy, 2-methylbutoxy, n-pentoxy, n-hexoxy, n-heptyloxy, n-octyloxy, n-nonyloxy, n-decyloxy, n-undecyloxy, n-dodecyloxy, etc.

Preferred amino groups are, for example, dimethylamino, methylamino, methylphenylamino, phenylamino, etc.

Aryl and heteroaryl groups can be monocyclic or polycyclic, i.e. they can have one ring (such as, for example, phenyl) or two or more rings, which may also be fused (such as, for example, naphthyl) or covalently linked (such as, for example, biphenyl), or contain a combination of fused and linked rings. Heteroaryl groups contain one or more heteroatoms, preferably selected from O, N, S and Se.

Preference is given to mono-, bi-, or tricyclic aryl groups having 6 to 25 C atoms and mono-, bi- or tricyclic heteroaryl groups having 2 to 25 C atoms, which optionally contain fused rings, and which are optionally substituted. Preference is furthermore given to 5-, 6- or 7-membered aryl and heteroaryl groups, in which, in addition, one or more CH groups may be replaced by N, S or O in such a way that O atoms and/or S atoms are not linked directly to one another.

Preferred aryl groups are, for example, phenyl, biphenyl, terphenyl, [1,1′:3′,1″ ]terphenyl-2′-yl, naphthyl, anthracene, binaphthyl, phenanthrene, pyrene, dihydropyrene, chrysene, perylene, tetracene, pentacene, benzopyrene, fluorene, indene, indenofluorene, spirobifluorene, etc.

Preferred heteroaryl groups are, for example, 5-membered rings, such as pyrrole, pyrazole, imidazole, 1,2,3-triazole, 1,2,4-triazole, tetrazole, furan, thiophene, selenophene, oxazole, isoxazole, 1,2-thiazole, 1,3-thiazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6-membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, isoindole, indolizine, indazole, benzimidazole, benzotriazole, purine, naphthimidazole, phenanthrimidazole, pyridimidazole, pyrazinimidazole, quinoxalinimidazole, benzoxazole, naphthoxazole, anthroxazole, phenanthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]thiophene, dithienothiophene, isobenzothiophene, dibenzothiophene, benzothiadiazothiophene, or combinations of these groups. The heteroaryl groups may also be substituted by alkyl, alkoxy, thioalkyl, fluorine, fluoroalkyl or further aryl or heteroaryl groups.

The (non-aromatic) alicyclic and heterocyclic groups encompass both saturated rings, i.e. those that contain exclusively single bonds, and partially unsaturated rings, i.e. those that may also contain multiple bonds. Heterocyclic rings contain one or more heteroatoms, preferably selected from Si, O, N, S and Se.

The (non-aromatic) alicyclic and heterocyclic groups can be monocyclic, i.e. contain only one ring (such as, for example, cyclohexane), or polycyclic, i.e. contain a plurality of rings (such as, for example, decahydronaphthalene or bicyclooctane). Preference is given to saturated groups. Preference is furthermore given to mono-, bi-, or tricyclic groups having 3 to 25 C atoms, which optionally contain fused rings and which are optionally substituted. Preference is furthermore given to 5-, 6-, 7- or 8-membered carbocyclic groups in which, in addition, one or more C atoms may be replaced by Si and/or one or more CH groups may be replaced by N and/or one or more non-adjacent CH₂ groups may be replaced by —O— and/or —S—.

Preferred alicyclic and heterocyclic groups are, for example, 5-membered groups, such as cyclopentane, tetrahydrofuran, tetrahydrothiofuran, pyrrolidine, 6-membered groups, such as cyclohexane, silinane, cyclohexene, tetrahydropyran, tetrahydrothiopyran, 1,3-dioxane, 1,3-dithiane, piperidine, 7-membered groups, such as cycloheptane, and fused groups, such as tetrahydronaphthalene, decahydronaphthalene, indane, bicyclo[1.1.1]pentane-1,3-diyl, bicyclo[2.2.2]octane-1,4-diyl, spiro[3.3]heptane-2,6-diyl, octahydro-4,7-methanoindane-2,5-diyl.

The aryl, heteroaryl, (non-aromatic) alicyclic and heterocyclic groups optionally have one or more substituents, which are preferably selected from the group comprising silyl, sulfo, sulfonyl, formyl, amine, imine, nitrile, mercapto, nitro, halogen, C₁-C₁₂ alkyl, C₆-C₁₂ aryl, C₁-C₁₂ alkoxy, hydroxyl, or combinations of these groups.

Preferred substituents are, for example, solubility-promoting groups, such as alkyl or alkoxy, electron-withdrawing groups, such as fluorine, nitro or nitrile, or substituents for increasing the glass transition temperature (Tg) in the polymer, in particular bulky groups, such as, for example, t-butyl or optionally substituted aryl groups.

Preferred substituents, also referred to as “L” below, are, for example, F, Cl, Br, I, —OH, —CN, —NO₂, —NCO, —NCS, —OCN, —SCN, —C(═O)N(R^{x})₂, —C(═O)Y^{x}, —C(═O)R^{x}, —C(═O)OR^{x}, —N(R^{x})₂, in which R^{x} has the above-mentioned meaning, and above Y^{X} denotes halogen, optionally substituted silyl, optionally substituted aryl or heteroaryl having 4 to 40, preferably 4 to 20 ring atoms, and straight-chain or branched alkyl, alkenyl, alkinyl, alkoxy, alkylcarbonyl, alkoxycarbonyl, alkylcarbonyloxy or alkoxycarbonyloxy having 1 to 25 C atoms, in which one or more H atoms may optionally be replaced by F or Cl.

“Substituted silyl or aryl” preferably means substituted by halogen, —CN, R^{y}, —OR^{y}, —CO—R^{y}, —CO—O—R^{y}, —O—CO—R^{y} or —O—CO—O—R^{y}, in which R^{y} denotes H, a straight-chain, branched or cyclic alkyl chain having 1 to 12 C atoms.

In the formula shown above and below, a substituted phenylene ring

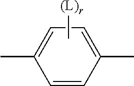

is preferably

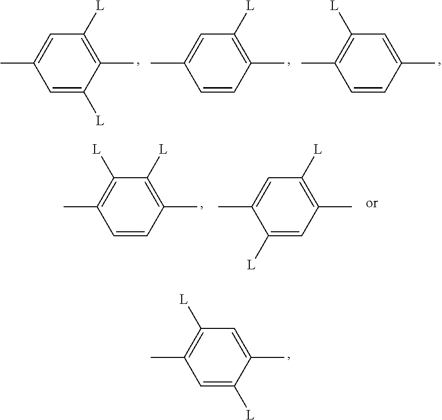

in which L has, on each occurrence identically or differently, one of the meanings given above and below, and is preferably F, Cl, CN, NO₂, CH₃, C₂H₅, C(CH₃)₃, CH(CH₃)₂, CH₂CH(CH₃)C₂H₅, OCH₃, OC₂H₅, COCH₃, COC₂H₅, COOCH₃, COOC₂H₅, CF₃, OCF₃, OCHF₂, OC₂F₅ or P-Sp-, very preferably F, Cl, CN, CH₃, C₂H₅, OCH₃, COCH₃, OCF₃ or P-Sp-, most preferably F, C₁, CH₃, OCH₃, COCH₃ or OCF₃.

“Halogen” denotes F, Cl, Br or I, preferably F or Cl, more preferably F.

“Polymerisable groups” (P) are preferably selected from groups containing a C═C double bond or C≡C triple bond, and groups which are suitable for polymerisation with ring opening, such as, for example, oxetane or epoxide groups.

Preferably, polymerisable groups (P) are selected from the group consisting of
CH₂═CW¹—COO—, CH₂═CW¹—CO—

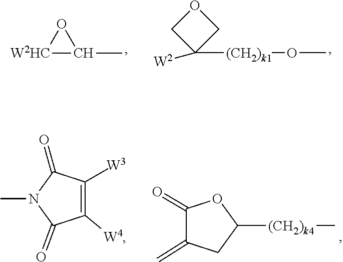

CH₂═CW²—(O)ₖ₃—, CW¹═CH—CO—(O)ₖ₃—, CW¹═CH—CO—NH—, CH₂═CW¹—CO—NH—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH—, in which
W¹ denotes H, F, Cl, CN, CF₃, phenyl or alkyl having 1 to 5 C atoms, in particular H, F, Cl or CH₃,
W² denotes H or alkyl having 1 to 5 C atoms, in particular H, methyl, ethyl, or n-propyl,
W³ and W⁴ each, independently of one another, denote H, Cl or alkyl having 1 to 5 C atoms, Phe denotes 1,4-phenylene, which is optionally substituted by one or more radicals L as being defined above but being different from P-Sp, preferably preferred substituents L are F, Cl, CN, NO₂, CH₃, C₂H₅, OCH₃, OC₂H₅, COCH₃, COC₂H₅, COOCH₃, COOC₂H₅, CF₃, OCF₃, OCHF₂, OC₂F₅, furthermore phenyl, and
k₁, k₂ and k₃ each, independently of one another, denote 0 or 1, k₃ preferably denotes 1, and k₄ is an integer from 1 to 10.

Particularly preferred polymerisable groups P are CH₂═CH—COO—, CH₂═C(CH₃)—COO—, CH₂═CF—COO—, CH₂═CH—, CH₂═CH—O—, (CH₂═CH)₂CH—OCO—, (CH₂═CH)₂CH—O—,

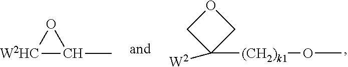

in which W² denotes H or alkyl having 1 to 5 C atoms, in particular H, methyl, ethyl or n-propyl,

Further preferred polymerisable groups (P) are vinyloxy, acrylate, methacrylate, fluoroacrylate, chloroacrylate, oxetane and epoxide, most preferably acrylate or methacrylate, in particular acrylate.

Preferably, all multireactive polymerisable compounds and sub-formulae thereof contain instead of one or more radicals P-Sp-, one or more branched radicals containing two or more polymerisable groups P (multireactive polymerisable radicals).

Suitable radicals of this type, and polymerisable compounds containing them, are described, for example, in U.S. Pat. No. 7,060,200 B1 or US 2006/0172090 A1.

Preference is given to multireactive polymerisable radicals selected from the following formulae:

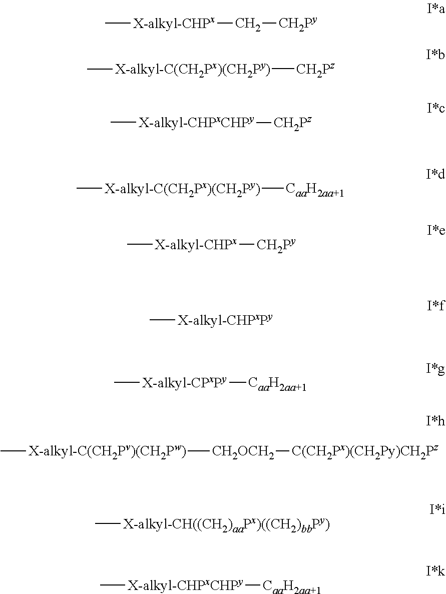

in which
alkyl denotes a single bond or straight-chain or branched alkylene having 1 to 12 C atoms, in which one or more non-adjacent CH₂ groups may each be replaced, independently of one another, by —C(R^{x})═C(R^{x})—, —C≡C—, —N(R^{x})—, —O—, —S—, —CO—, —CO—O—, —O—CO—, —O—CO—O— in such a way that O and/or S atoms are not linked directly to one another, and in which, in addition, one or more H atoms may be replaced by F, C₁ or CN, where R^{x} has one the above-mentioned meaning,
aa and bb each, independently of one another, denote 0, 1, 2, 3, 4, 5 or 6,
X has one of the meanings indicated for X, and
P^{v} to P^{z} each, independently of one another, have one of the meanings indicated above for P.

Preferred spacer groups Sp are selected from the formula Sp′-X′, so that the radical “P-Sp-” conforms to the formula “P-Sp′-X′—”, where
Sp′ denotes alkylene having 1 to 20, preferably 1 to 12 C atoms, which is optionally mono- or polysubstituted by F, Cl, Br, I or CN and in which, in addition, one or more non-adjacent CH₂ groups may each be replaced, independently of one another, by —O—, —S—, —NH—, —NR^{xx}—, —SiR^{xx}R^{yy}—, —CO—, —COO—, —OCO—, —OCO—O—, —S—CO—, —CO—S—, —NR^{xx}—CO—O—, —O—CO—NR^{xx}—, —NR^{xx}—CO—NR^{yy}—, —CH═CH— or —C≡C— in such a way that O and/or S atoms are not linked directly to one another,
X′ denotes —O—, —S—, —CO—, —COO—, —OCO—, —O—COO—, —CO—NR^{xx}—, —NR^{xx}—CO—, —NR^{xx}—CO—NR^{yy}—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR^{xx}—, —CY^{xx}═CY^{xx}—, —C≡C—, —CH═CH—COO—, —OCO—CH═CH— or a single bond,
R^{xx} and R^{yy} each, independently of one another, denote H or alkyl having 1 to 12 C atoms, and
Y^{xx} and Y^{yy} each, independently of one another, denote H, F, Cl or CN.
X′ is preferably —O—, —S—, —CO—, —COO—, —OCO—, —O—COO—, —CO—NR^{xx}—, —NR^{xx}—CO—, —NR^{xx}—CO—NR^{yy}— or a single bond.

Typical spacer groups Sp′ are, for example, —(CH₂)ₚ₁—, —(CH₂CH₂O)_{q1}—CH₂CH₂—, —CH₂CH₂—S—CH₂CH₂—, —CH₂CH₂—NH—CH₂CH₂— or —(SiR^{xx}R^{yy}—O)ₚ₁—, in which p1 is an integer from 1 to 12, q1 is an integer from 1 to 3, and R^{x} and R^{yy} have the above-mentioned meanings.

Particularly preferred groups —X′-Sp′- are —(CH₂)ₚ₁—, —O—(CH₂)ₚ₁—, —OCO—(CH₂)ₚ₁—, —OCOO—(CH₂)ₚ₁—, in which p1 is an integer from 1 to 12.

Particularly preferred groups Sp′ are, for example, in each case straight-chain, methylene, ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyliminoethylene, 1-methylalkylene, ethenylene, propenylene and butenylene.

For the present invention,

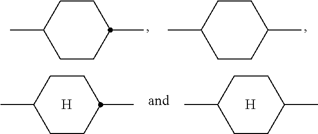

denote trans-1,4-cyclohexylene, and

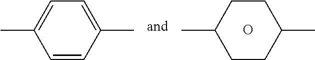

denote 1,4-phenylene.

For the present invention the groups —COO— —C(═O)O— or —CO₂— denote an ester group of formula,

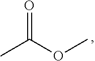

and the groups —OCO—, —OC(═O)—, —O₂C— or —OOC— denote an ester group of formula

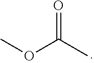

All concentrations are quoted in percent by weight (w/w) and relate to the respective mixture as a whole, all temperatures are quoted in degrees Celsius, and all temperature differences are quoted in differential degrees.

Unless the context clearly indicates otherwise, as used herein plural forms of the terms herein are to be construed as including the singular form and vice versa.

Throughout the description and claims of this specification, the words “comprise” and “contain” and variations of the words, for example “comprising” and “comprises”, mean “including but not limited to”, and are not intended to (and do not) exclude other components. On the other hand, the word “comprise” also encompasses the term “consisting of” but is not limited to it.

Throughout the description and claims of this specification, the words “obtainable” and “obtained” and variations of the words, mean “including but not limited to”, and are not intended to (and do not) exclude other components. On the other hand, the word “obtainable” also encompasses the term “obtained” but is not limited to it.

### DETAILED DESCRIPTION OF THE INVENTION

Usually, when preparing a reverse optical dispersion QWP from polymer films comprising polymerised RMs or polymerised RM mixtures (RMMs), hereinafter also referred to as “RM film(s)”, a portion of the RM film or RM film stack must have perpendicular director orientation to the bulk, as in the HWP+QWP combination known from prior art as described above.

In contrast thereto, the polymer film according to the present invention has planar alignment, and by adding a small amount of a chiral dopant with high twisting power a helical twist is induced in a direction throughout the film thickness. As a result a perpendicular director orientation can be provided in a single film using only positive dispersion materials. This enables low material cost and increases market competitiveness.

Furthermore, the polymer film according to the present invention shows a biased helical pitch (or helical pitch gradient), i.e., wherein the chiral twist angle increases or decreases incrementally through the film thickness (i.e., in a direction perpendicular to the film plane). By using materials and methods according to this invention such a structure can already be achieved by application of low intensity UV light.

The polymerisable LC medium according to the present invention preferably comprises
a nematic RM host mixture, comprising one or more di- or multireactive mesogenic compounds, and optionally one or more monoreactive mesogenic compounds, and
a chiral component comprising one or more chiral compounds with (s)-configuration and one or more chiral compounds with (R)-configuration, wherein at least one of the chiral compounds is photoreactive, and preferably comprises an photoisomerisable group and
optionally a photoinitiator.

Preferably the process of preparing a polymer film according to the present invention only requires one additional production step compared to the process of preparing a conventional planar aligned RM film. This extra step is a low intensity UV exposure in air to cause photoisomerisation of the chiral compound, and does not require an inert gas atmosphere or additional heating or cooling of the film.

In preferred embodiment, the polymerisable LC medium comprises one or more di- or multireactive RMs that are preferably selected of formula DRM

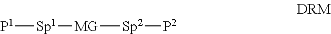

wherein
P¹ and P² independently of each other denote a polymerisable group,
Sp¹ and Sp² independently of each other are a spacer group or a single bond, and
MG is a rod-shaped mesogenic group, which is preferably selected of formula MG

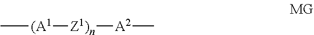

wherein
A¹ and A² denote, in case of multiple occurrence independently of one another, an aromatic or alicyclic group, which optionally contains one or more heteroatoms selected from N, O and S, and is optionally mono- or polysubstituted by L,
L is P-Sp-, F, Cl, Br, I, —CN, —NO₂, —NCO, —NCS, —OCN, —SCN, —C(═O)NR^{x}R^{y}, —C(═O)OR^{x}, —C(═O)R^{x}, —NR^{x}R^{y}, —OH, —SF₅, optionally substituted silyl, aryl or heteroaryl with 1 to 12, preferably 1 to 6 C atoms, and straight chain or branched alkyl, alkoxy, alkylcarbonyl, alkoxycarbonyl, alkylcarbonyloxy or alkoxycarbonyloxy with 1 to 12, preferably 1 to 6 C atoms, wherein one or more H atoms are optionally replaced by F or Cl,
R^{x} and R^{y} independently of each other denote H or alkyl with 1 to 12 C-atoms,
Z¹ denotes, in case of multiple occurrence independently of one another, —O—, —S—, —CO—, —COO—, —OCO—, —S—CO—, —CO—S—, —O—COO—, —CO—NR^{x}—, —NR^{x}—CO—, —NR^{x}—CO—NR^{y}, —NR^{x}—CO—O—, —O—CO—NR^{x}—, —OCH₂—, —CH₂O—, —SCH₂—, —CH₂S—, —CF₂O—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR^{x}—, —CY¹═CY²—, —C≡C—, —CH═CH—COO—, —OCO—CH═CH— or a single bond, preferably —COO—, —OCO— or a single bond,
Y¹ and Y² independently of each other denote H, F, Cl or CN,
n is 1, 2, 3 or 4, preferably 1 or 2, most preferably 2,
n1 is an integer from 1 to 10, preferably 1, 2, 3 or 4.

Preferred groups A¹ and A² include, without limitation, furan, pyrrol, thiophene, oxazole, thiazole, thiadiazole, imidazole, phenylene, cyclohexylene, bicyclooctylene, cyclohexenylene, pyridine, pyrimidine, pyrazine, azulene, indane, fluorene, naphthalene, tetrahydronaphthalene, anthracene, phenanthrene and dithienothiophene, all of which are unsubstituted or substituted by 1, 2, 3 or 4 groups L as defined above.

Particular preferred groups A¹ and A² are selected from 1,4-phenylene, pyridine-2,5-diyl, pyrimidine-2,5-diyl, thiophene-2,5-diyl, naphthalene-2,6-diyl, 1,2,3,4-tetrahydro-naphthalene-2,6-diyl, indane-2,5-diyl, bicyclooctylene or 1,4-cyclohexylene wherein one or two non-adjacent CH₂ groups are optionally replaced by O and/or S, wherein these groups are unsubstituted or substituted by 1, 2, 3 or 4 groups L as defined above.

Preferred RMs of formula DRM are selected of formula DRMa

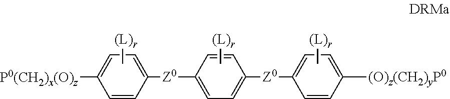

wherein
P⁰ is, in case of multiple occurrence independently of one another, a polymerisable group, preferably an acryl, methacryl, oxetane, epoxy, vinyl, heptadiene, vinyloxy, propenyl ether or styrene group,
Z⁰ is —COO—, —OCO—, —CH₂CH₂—, —CF₂O—, —OCF₂—, —C≡C—, —CH═CH—, —OCO—CH═CH—, —CH═CH—COO—, or a single bond,
L has on each occurrence identically or differently one of the meanings given for L¹ in formula I, and is preferably, in case of multiple occurrence independently of one another, selected from F, Cl, CN or optionally halogenated alkyl, alkoxy, alkylcarbonyl, alkoxycarbonyl, alkylcarbonyloxy or alkoxycarbonyloxy with 1 to 5 C atoms,
r is 0, 1, 2, 3 or 4,
x and y are independently of each other 0 or identical or different integers from 1 to 12,
z is 0 or 1, with z being 0 if the adjacent x or y is 0.

Very preferred RMs of formula DRM are selected from the following formulae:

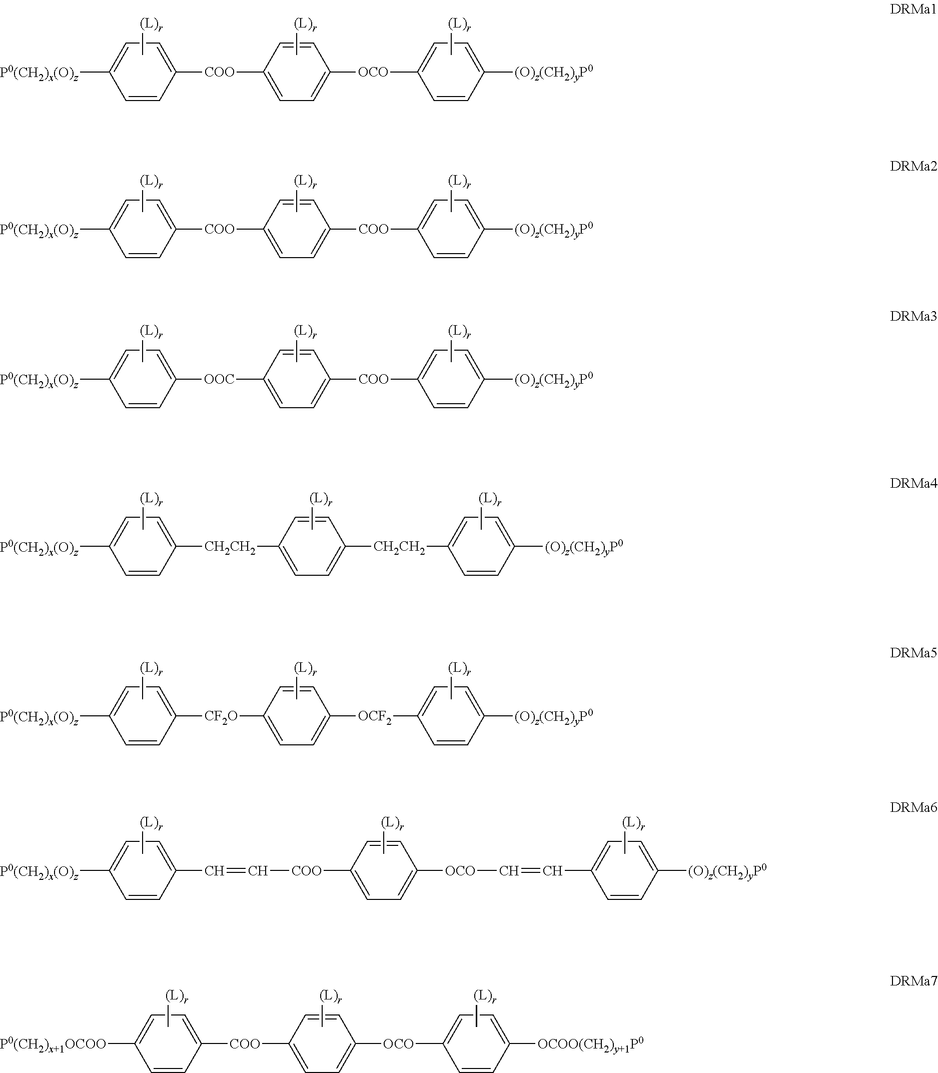

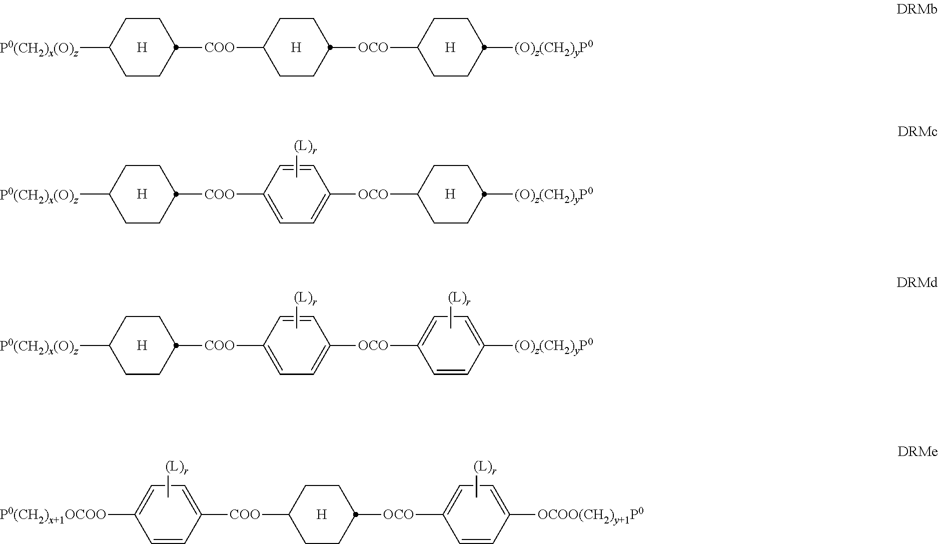

wherein P°, L, r, x, y and z are as defined in formula DRMa.

Especially preferred are compounds of formula DRMa1, DRMa2 and DRMa3, in particular those of formula DRMa1.

The concentration of di- or multireactive RMs, preferably those of formula DRM and its subformulae, in the RM mixture is preferably from 1% to 60%, very preferably from 10 to 60%, more preferably 20 to 55%.

In preferred embodiment, the polymerisable LC medium comprises one or more monoreactive RMs additionally to the di- or multireactive RMs that are preferably selected of formula DRM

These additional monoreactive RMs are preferably selected from compounds of formula MRM:

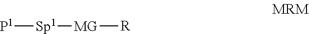

wherein P¹, Sp¹ and MG have the meanings given in formula DRM,
R denotes P-Sp-, F, Cl, Br, I, —CN, —NO₂, —NCO, —NCS, —OCN, —SCN, —C(═O)NR^{x}R^{y}, —C(═O)X, —C(═O)OR^{x}, —C(═O)R^{y}, —NR^{x}R^{y}, —OH, —SF₅, optionally substituted silyl, straight chain or branched alkyl, alkoxy, alkylcarbonyl, alkoxycarbonyl, alkylcarbonyloxy or alkoxycarbonyloxy with 1 to 12, preferably 1 to 6 C atoms, wherein one or more H atoms are optionally replaced by F or Cl,
X is halogen, preferably F or Cl, and
R^{x} and R^{y} are independently of each other H or alkyl with 1 to 12 C-atoms.

Preferably the RMs of formula MRM are selected from the following formulae.

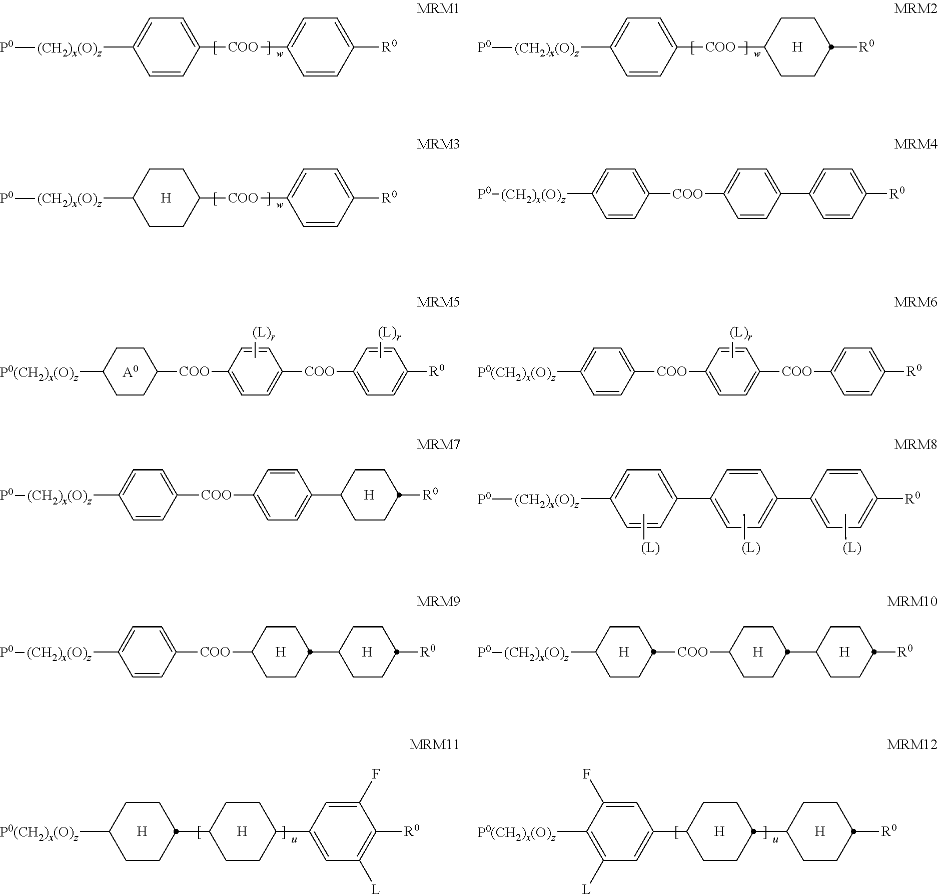

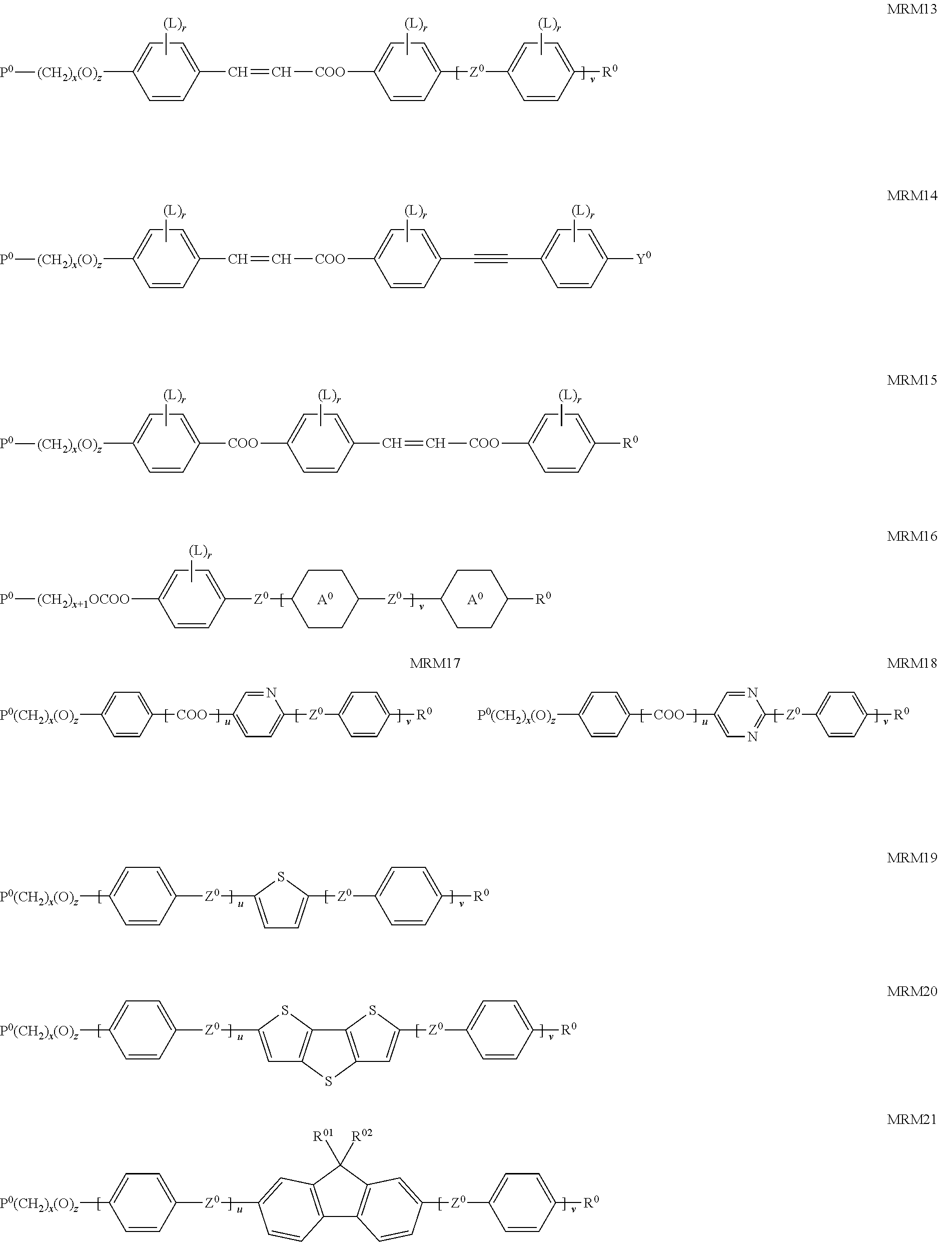

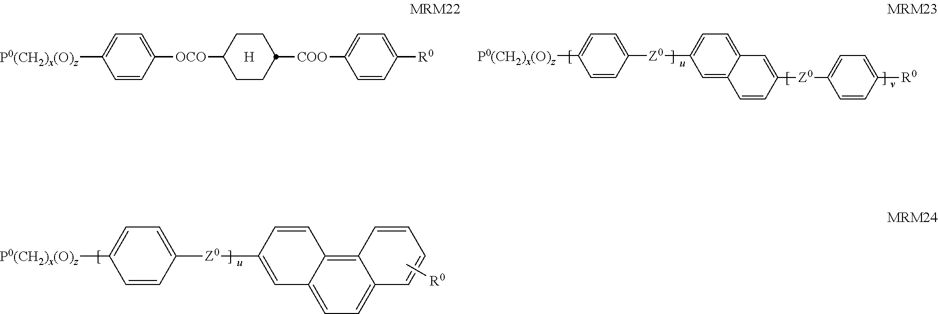

wherein P⁰, L, r, x, y and z are as defined in formula DRMa,
R⁰ is alkyl, alkoxy, thioalkyl, alkylcarbonyl, alkoxycarbonyl, alkylcarbonyloxy or alkoxycarbonyloxy with 1 or more, preferably 1 to 15 C atoms or denotes Y⁰ or P—(CH₂)_{y}—(O)_{z}—,
X⁰ is —O—, —S—, —CO—, —COO—, —OCO—, —O—COO—, —CO—NR⁰¹—, —NR⁰¹—CO—, —NR⁰¹—CO—NR⁰¹—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰¹—, —CF═CF—, —C≡C—, —CH═CH—COO—, —OCO—CH═CH— or a single bond,
Y⁰ is F, Cl, CN, NO₂, OCH₃, OCN, SCN, SF₅, or mono- oligo- or polyfluorinated alkyl or alkoxy with 1 to 4 C atoms,
Z⁰ is —COO—, —OCO—, —CH₂CH₂—, —CF₂O—, —OCF₂—, —CH═CH—, —OCO—CH═CH—, —CH═CH—COO—, or a single bond,
A⁰ is, in case of multiple occurrence independently of one another, 1,4-phenylene that is unsubstituted or substituted with 1, 2, 3 or 4 groups L, or trans-1,4-cyclohexylene,
R^{01,02} are independently of each other H, R⁰ or Y⁰,
u and v are independently of each other 0, 1 or 2,
w is 0 or 1,
and wherein the benzene and naphthalene rings can additionally be substituted with one or more identical or different groups L.

Especially preferred are compounds of formula MRM1, MRM2, MRM3, MRM4, MRM5, MRM6, MRM7, in particular those of formula MRM1, MRM4, MRM6, and MRM7.

The concentration of all monoreactive RMs in the polymerisable LC medium is preferably from 1 to 80%, very preferably from 5 to 70%, more preferably 10 to 60%.

The compounds of the formulae DRM, MRM, and sub-formulae thereof can be pre-pared analogously to processes known to the person skilled in the art and described in standard works of organic chemistry, such as, for example, in Houben-Weyl, Methoden der organischen Chemie [Methods of Organic Chemistry], Thieme-Verlag, Stuttgart.

In a preferred embodiment, the proportion of polymerisable mesogenic compounds in the polymerisable liquid-crystalline medium according to the present invention as a whole, is in the range from 30 to 99% by weight, more preferably in the range from 40 to 97% by weight and even more preferably in the range from 50 to 95% by weight.

Preferably, the proportion of said mono-, di- or multireactive liquid-crystalline compounds, preferably selected from the compounds of the formulae DRM, MRM as given above and below in the polymerisable liquid-crystalline medium according to the present invention as a whole, is preferably in the range from 30 to 99.9% by weight, more preferably in the range from 40 to 99.9% by weight and even more preferably in the range from 50 to 99.9% by weight.

In a preferred embodiment, the proportion of di- or multireactive polymerisable mesogenic compounds in the polymerisable liquid-crystalline medium according to the present invention as a whole, is preferably in the range from 5 to 99% by weight, more preferably in the range from 10 to 97% by weight and even more preferably in the range from 15 to 95% by weight.

In another preferred embodiment, the proportion of monoreactive polymerisable mesogenic compounds in a polymerisable liquid-crystalline medium according to the present invention as a whole, is, if present, preferably in the range from 5 to 80% by weight, more preferably in the range from 10 to 75% by weight and even more preferably in the range from 15 to 70% by weight.

In another preferred embodiment, the proportion of multireactive polymerisable mesogenic compounds in a polymerisable liquid-crystalline medium according to the present invention as a whole is, if present, preferably in the range from 1 to 30% by weight, more preferably in the range from 2 to 20% by weight and even more preferably in the range from 3 to 10% by weight.

In another preferred embodiment, the proportion of di- or multireactive polymerisable mesogenic compounds in a polymerisable liquid-crystalline medium according to the present invention as a whole is in the range from 20 to 70% by weight, more preferably in the range from 30 to 60% by weight, and the proportion of monoreactive polymerisable mesogenic compounds in a polymerisable liquid-crystalline medium according to the present invention as a whole is in the range from 10 to 60% by weight, more preferably in the range from 20 to 50% by weight.

In another preferred embodiment the polymerisable LC medium does not contain polymerisable mesogenic compounds having more than two polymerisable groups.

In another preferred embodiment the polymerisable LC medium does not contain polymerisable mesogenic compounds having less than two polymerisable groups.

In a further preferred embodiment, the polymerisable LC material comprises one or more monoreactive mesogenic compounds, preferably selected from formulae MRM1, MRM7, MRM9 and MRM10, and one or more direactive mesogenic compounds, preferably selected from formula DRMa1.

In a further preferred embodiment, the polymerisable LC medium comprises at least two monoreactive mesogenic compounds, preferably selected from compounds of formulae MRM1, MRM7, MRM9 and MRM10, and one or more direactive mesogenic compounds, preferably selected from formula DRMa1.

In a further preferred embodiment, the polymerisable LC medium comprises at least two monoreactive mesogenic compounds, preferably selected from compounds of formulae MRM1, MRM7, MRM9 and MRM10, and at least two direactive mesogenic compounds, preferably selected from compounds of formula DRMa1.

In a further preferred embodiment, the polymerisable LC medium comprises at least two direactive mesogenic compounds, preferably selected from compounds of formula DRMa1.

The polymerisable LC medium preferably exhibits a nematic LC phase, or a smectic LC phase and a nematic LC phase, very preferably a nematic LC phase at room temperature.

Preferably the utilized chiral compounds of the polymerisable LC medium have each alone or in combination with each other an absolute value of the helical twisting power (HTP) of 20 μm⁻¹ or more, preferably of 40 μm⁻¹ or more, more preferably in the range of 60 μm⁻¹ or more, most preferably in the range of 80 μm⁻¹ or more to 260 μm⁻¹.

The chiral compounds preferably comprise a binaphthyl group, an isosorbide or an isomannide group. The photoreactive chiral compounds do preferably additionally comprise a cinnamate group, a stilbene group, an azo group or a Schiff base (—CH═N—) group, preferably a cinnamate group.

The chiral compounds can be polymerisable or non-polymerisable. The polymerisable chiral compounds preferably comprise one or more, preferably two, polymerisable groups P as described above and below, preferably selected from acrylate and methacrylate groups, very preferably from acrylate groups.

Preferably, non-polymerisable chiral compounds are selected from the group of compounds of formulae C-I to C-III,

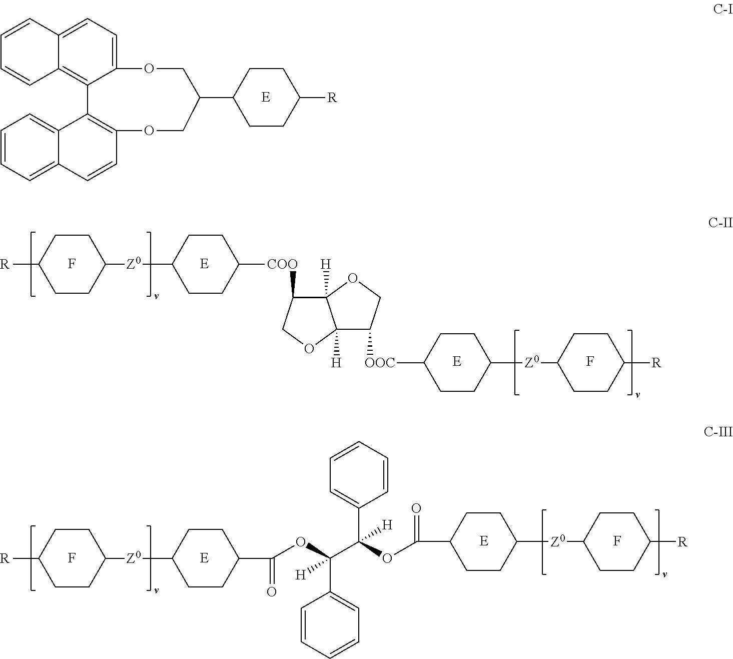

the latter ones including the respective (S,S) enantiomers,
wherein E and F are each independently 1,4-phenylene or trans-1,4-cyclohexylene, v is 0 or 1, Z⁰ is —COO—, —OCO—, —CH₂CH₂— or a single bond, and R is alkyl, alkoxy or alkanoyl with 1 to 12 C atoms.

Particularly preferred polymerisable LC mediums that comprise one or more chiral compounds, which do not necessarily have to show a liquid crystalline phase.

The compounds of formula C-II and their synthesis are described in WO 98/00428. The compounds of formula C-III and their synthesis are described in GB 2 328 207.

Further, typically used chiral compounds are e.g. the commercially available R/S-5011, R/S-811 and CB-15 (from Merck KGaA, Darmstadt, Germany).

The above mentioned chiral compounds R/S-5011 and the (other) compounds of formulae C-I, C-II and C-III exhibit a very high helical twisting power (HTP), and are therefore particularly useful for the purpose of the present invention.

The polymerisable LC medium preferably comprises 1 to 5, in particular 1 to 3, very preferably 1 or 2 chiral compounds, preferably selected from the above formula C-II, and/or formula C-III and/or R-5011 or S-5011, very preferably, the chiral compound is R-5011, S-5011.

Preferably the polymerisable LC medium comprise one or more non-reactive chiral compound and/or one or more mono-, di- and/or multireactive chiral compounds.

Further preferably the polymerisable LC medium comprises only polymerisable chiral compounds, preferably selected from direactive compounds.

Suitable mesogenic reactive chiral compounds preferably comprise one or more ring elements, linked together by a direct bond or via a linking group and, where two of these ring elements optionally may be linked to each other, either directly or via a linking group, which may be identical to or different from the linking group mentioned. The ring elements are preferably selected from the group of four-, five-, six- or seven-, preferably of five- or six-, membered rings.

Preferred mono- or direactive chiral compounds are selected from compounds of formula CRMa, CRMb and CRMc:

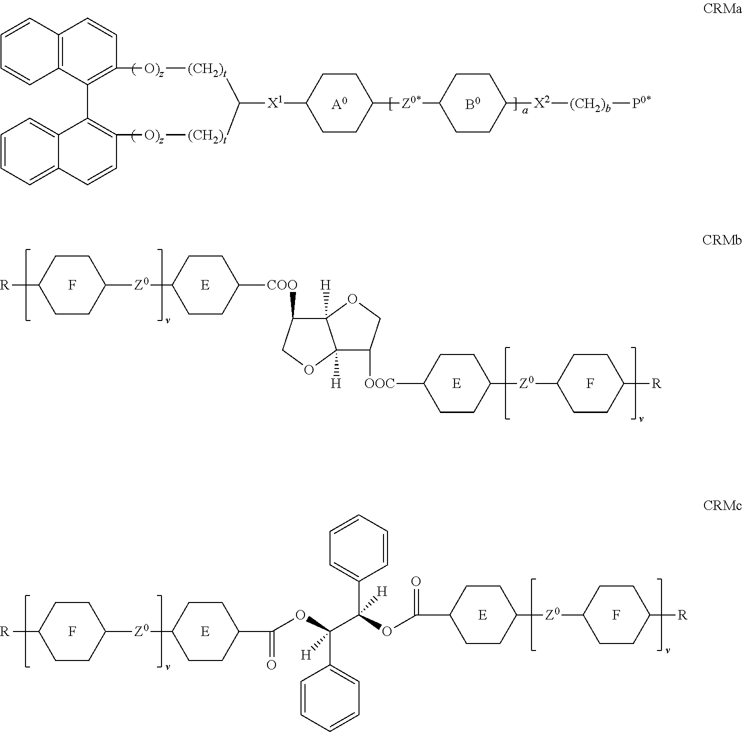

wherein
P^{0*} denotes a polymerisable group P
Sp* denotes a spacer Sp
R denotes P⁰— or P⁰—Sp*-,
A⁰ and B⁰ are, in case of multiple occurrence independently of one another, 1,4-phenylene that is unsubstituted or substituted with 1, 2, 3 or 4 groups L as defined above, or trans-1,4-cyclohexylene,
X¹ and X² are independently of each other —O—, —COO—, —OCO—, —O—CO—O— or a single bond,
Z^{0*} is, in case of multiple occurrence independently of one another, —COO—, —OCO—, —O—CO—O—, —OCH₂—, —CH₂O—, —CF₂O—, —OCF₂—, —CH₂CH₂—, —(CH₂)₄—, —CF₂CH₂—, —CH₂CF₂—, —CF₂CF₂—, —C≡C—, —CH═CH—, —CH═CH—COO—, —OCO—CH═CH— or a single bond,
t is, independently of each other 0, 1, 2 or 3,
a is 0, 1 or 2,
b is 0 or an integer from 1 to 12,
z is 0 or 1,
and wherein the naphthalene rings can additionally be substituted with one or more identical or different groups L
wherein
L is, independently of each other F, Cl, CN, halogenated alkyl, alkoxy, alkylcarbonyl, alkoxycarbonyl, alkylcarbonyloxy or alkoxycarbonyloxy with 1 to 5 C atoms.

The compounds of formula CRM are preferably selected from the group of compounds of the following formula

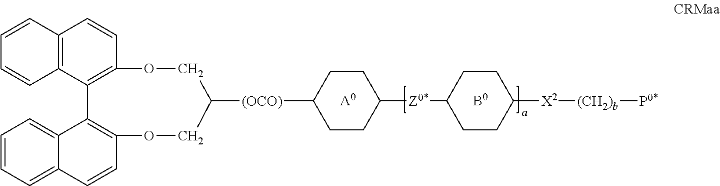

wherein A⁰, B⁰, Z^{0*}, P^{0*}, a and b have the meanings given in formula CRM or one of the preferred meanings given above and below, and (OCO) denotes —O—CO— or a single bond.

Especially preferred compounds of formula CRM are selected from the group consisting of the following subformulae:

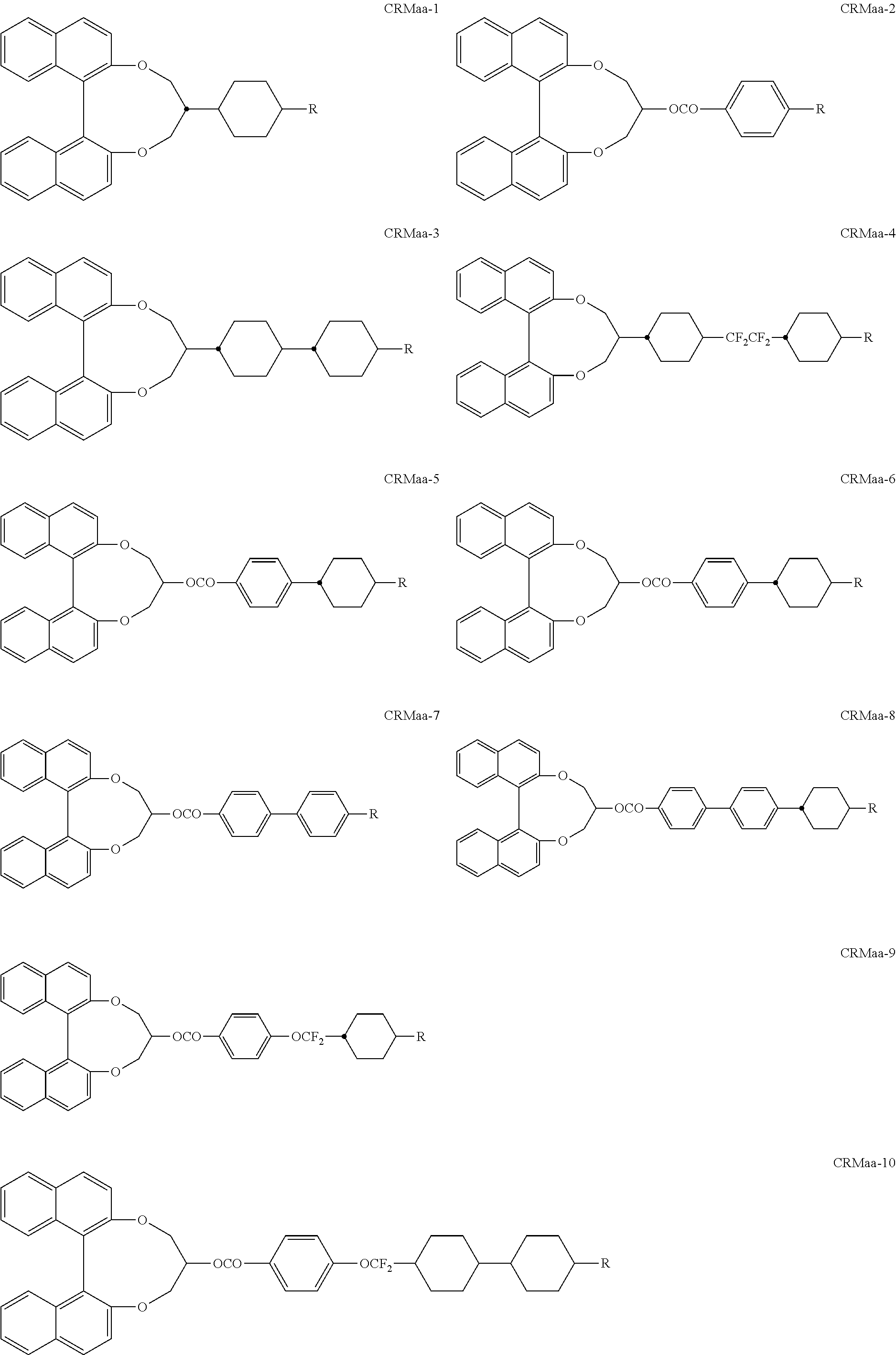

wherein R is —X²—(CH₂)ₓ—P^{0*} as defined in formula CRMaa, and the benzene and naphthalene rings are unsubstituted or substituted with 1, 2, 3 or 4 groups L as defined above and below.

In a preferred embodiment, the polymerisable LC medium comprises at least one photoreactive chiral compound in R configuration, and at least one chiral compound of S configuration, preferably selected from the chiral compounds of formulae CRMa to CRMc.

In a preferred embodiment, the polymerisable LC medium comprises at least one photoreactive chiral compound in S configuration, and at least one chiral compound of R configuration, preferably selected from the chiral compounds of formulae CRMa to CRMc.

In a preferred embodiment, The polymerisable LC medium comprises at least one photoreactive chiral compound in R or S configuration.

In a preferred embodiment the configuration of the photoreactive chiral compound is selected to be different from the configuration of the chiral compound which does not comprise a photoreactive group. For instance, if a chiral compound is selected with R configuration then a photoreactive chiral compound of S configuration is preferred and vice versa. Accordingly, the individual values for the HTP of the individual chiral compounds with different configuration may compensate each other in terms of their individual helical twisting power to give a resulting absolute value of the HTP, hereinafter also named IHTP_{Δ}I.

In a preferred embodiment, the polymerisable LC medium comprises one or more chiral compounds with (S)-configuration, and additionally one or more chiral compounds with (R)-configuration, wherein at least one of said chiral compounds either in (S) configuration or in (R) configuration is selected from photoreactive chiral compounds and the resulting IHTP_{Δ}I is in the range from 0.1 μm⁻¹ to 100 μm⁻¹, more preferably in the range of 0.5 μm⁻¹ to 50 μm⁻¹, most preferably in the range of 1 μm⁻¹ to 25 μm⁻¹.

The photoreactive chiral compounds are preferably selected from polymerisable photoreactive chiral compounds, preferably of compounds of formula I:

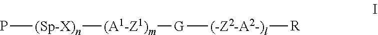

wherein
P is CH₂═CW—COO—, WCH═CH—O—,
   or CH₂═CH-Phenyl-(O)ₖ— with W being H, CH₃ or F, Cl and k being 0 or 1,
Sp is a spacer group having 1 to 20 C atoms,
X is a group selected from —O—, —S—, —CO—, —COO—, —OCO—, —OCO—O—, —S—CO—, —CO—S— or a single bond,
n is 0 or 1,
Z¹ and Z² are each independently —COO—, —OCO—, —CH₂CH₂—, —OCH₂—, —CH₂O—, —CH═CH—, —CH═CH—COO—, —OCO—CH═CH—, —C≡C—, or a single bond,
A¹ and A² are each independently 1,4-phenylene in which, in addition, one or more CH groups may be replaced by N, 1,4-cyclohexylene in which, in addition, one or two non-adjacent CH₂ groups may be replaced by 0 and/or S, 1,4-cyclohexenylene, 1,4-bicyclo(2,2,2)octylene, piperidine-1,4-diyl, naphthalene-2,6-diyl, decahydronaphthalene-2,6-diyl, or 1,2,3,4-tetrahydro-naphthalene-2,6-diyl, it being possible for all these groups to be unsubstituted, mono- or polysubstituted with halogen, cyano or nitro groups or alkyl, alkoxy or acyl groups having 1 to 7 C atoms wherein one or more H atoms may be substituted by F or Cl,
m and l are each independently 0, 1 or 2,
G is the following structure element

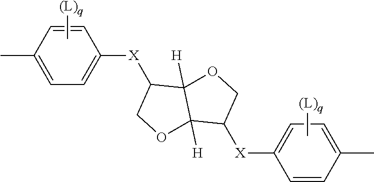

with q being 0, 1, 2, 3 or 4 and L being in each case independently halogen, a cyano or nitro group or an alkyl, alkoxy or acyl group having 1 to 7 C atoms wherein one or more H atoms may be substituted by F or Cl, X being photoreactive group, preferably a cinnamate- or an azo-group, and
R is an alkyl radical with up to 25 C atoms which may be unsubstituted, mono- or polysubstituted by halogen or CN, it being also possible for one or more non-adjacent CH₂ groups to be replaced, in each case independently from one another, by —O—, —S—, —NH—, —N(CH₃)—, —CO—, —COO— —OCO—, —OCO—O—, —S—CO—, —CO—S— or —C≡C— in such a manner that oxygen atoms are not linked directly to one another, or alternatively R is halogen, cyano or has independently one of the meanings given for P-(Sp-X)ₙ—.

In a preferred embodiment of the invention the photoreactive chiral compounds according to formula I are compounds of formula Ia

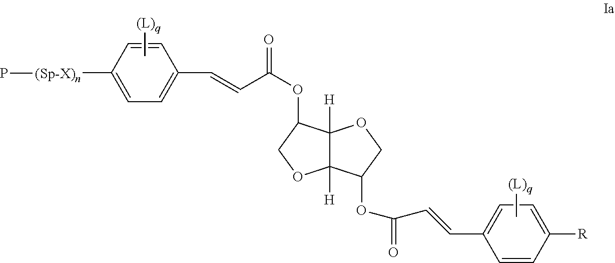

wherein P, Sp, X, n, L, q and R have the meanings given in formula I.

In the compounds of formula Ia, P is preferably acrylate or methacrylate, very preferably acrylate, (Sp-X)ₙ is preferably —O—(CH₂)ₚ₁—, —OCO—(CH₂)ₚ₁—, very preferably —O—(CH₂)ₚ₁—, in which p1 is an integer from 1 to 6, R is preferably P-(Sp-X)ₙ—, n is preferably 1 and q is preferably 0.

In another preferred embodiment of the invention the photoreactive chiral compounds are selected according to formula I or I a, wherein R has one of the meanings of P-(Sp-X)ₙ— given above.

In another preferred embodiment of the invention the photoreactive chiral compounds are compounds of formula I or I a, wherein R is halogen, cyano or an optionally fluorinated achiral or chiral alkyl or alkoxy group with 1 to 15 C atoms.

In another preferred embodiment of the invention the photoreactive chiral compounds are compounds of formula I or I a, wherein n is 1 and Sp is alkylene with 1 to 15 C atoms and X is —O—, —O—CO—, —CO—O— or a single bond.

Halogen is preferably F, Cl or Br, especially preferably F.

Of the photoreactive chiral compounds of formula I the following are preferred:

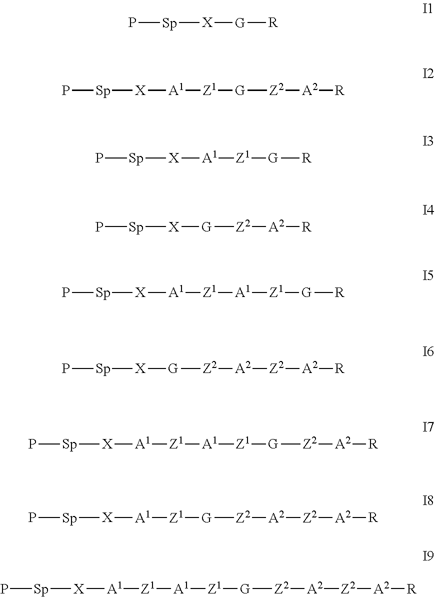

wherein P, Sp, X, A¹, A², Z¹, Z², G and R have the meanings given for formula I as described above.

Of these photoreactive chiral compounds, particularly preferred are those of formula I 1 to I 4, very particularly preferred those of formula I 1 and I 2.

Particularly preferred photoreactive chiral compounds of the formula I 1 are those wherein n is 1 and R is alkyl or alkoxy with 1 to 15 C atoms or has the meaning of P-Sp-X—. Furthermore —Sp-X— in the compounds of formula I 1 is preferably alkylene or alkyleneoxy with 1 to 12 C atoms.

Of the photoreactive chiral compounds of formula I 2 to I 9 especially preferred are those in which R is alkyl or alkoxy or has the meaning given for P-Sp-X— and Z¹ and Z² are each independently —COO—, —OCO—, —CH₂—CH₂— or a single bond.

Of the photoreactive chiral compounds wherein A¹ and A² denote a heterocyclic group, those containing a pyridine-2,5-diyl group, pyrimidine-2,5-diyl group or 1,3-dioxane-2,5-diyl group are particularly preferred.

A smaller group of particularly preferred photoreactive chiral compounds of the formulae I 2, I 3 and I 4 is listed below. For reasons of simplicity, PheS is 1,4-phenylene, which is substituted in 2- and/or 3-position with S, wherein S has one of the meanings of L as given in formula I as described above. Furthermore, Pyd is pyridine-2,5-diyl, Pyr is pyrimidine-2,5-diyl, Cyc is 1,4-cyclohexylene, Dio is trans-1,3-dioxane-2,5-diyl, Dit is trans-1,3-dithiane-2,5-diyl and Nap is a tetra- or decahydronaphthalene-2,6-diyl or naphthalene-2,6-diyl group. The notations Pyd, Pyr, Dio and Dit in each case include the 2 possible positional isomers.

Particularly preferred photoreactive chiral compounds of the formula I 2 are those of the following formulae:

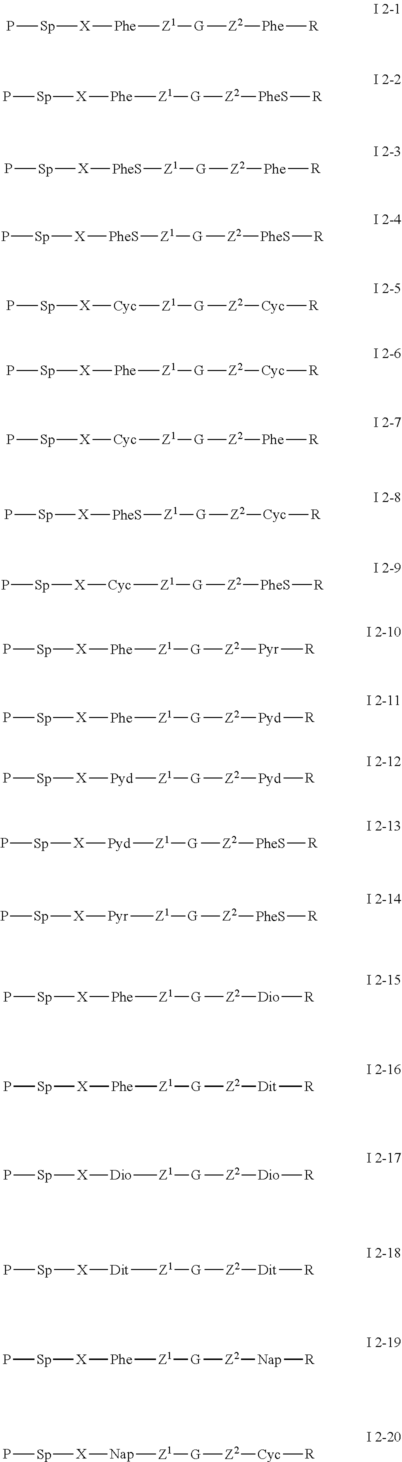

In the compounds of formula I 2-1 to I 2-20, P, Sp, X, G, Z¹, Z² and R have, unless otherwise indicated, the meanings given for formula I described above.

In the compounds of formula I 2-1 to I 2-20, R is very particularly preferably P-Sp-X— or an alkyl or alkoxy group having 1 to 15 C atoms. Furthermore, Z¹ in these compounds is very particularly preferably an ester group (—CO—O— or —O—CO—), —CH₂CH₂— or a single bond.

Of the compounds of formula I 2-1 to I 2-20, those of formula I 2-1 to I 2-9 are preferred. Especially preferred are the compounds of formula I 2-1 to I 2-4.

Particularly preferred photo reactive chiral compounds of the formula I 3 are those of the following formulae:

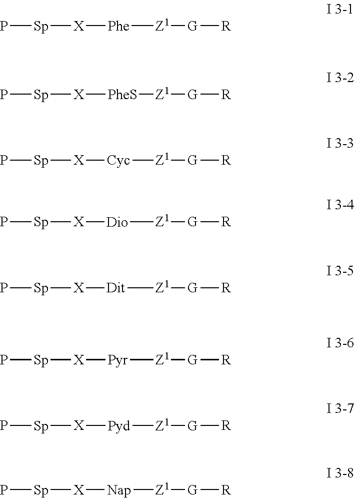

Particularly preferred photoreactive chiral compounds of formula I 4 are those of the following formulae:

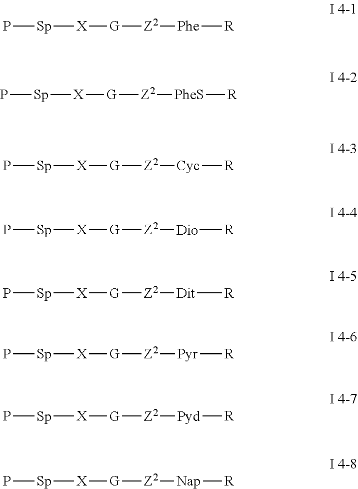

In the compounds of formula I 3-1 to I 3-8 and I 4-1 to I 4-8 P. Sp, X, G, Z¹, Z² and R, unless otherwise indicated, have the meanings given for formula I as described above.

Of the preferred compounds of the formulae I 3-1 to I 3-8 and I 4-1 to I 4-8 in particular preferred are those in which R is P-Sp-X— or an alkyl or alkoxy group having 1 to 15 C atoms and Z¹ is —COO—, —OCO—, —CH₂CH₂— or a single bond.

If R is an alkyl or alkoxy radical, i.e. where the terminal CH₂ group is replaced by —O—, this may be straight-chain or branched. It is preferably straight-chain, has 2, 3, 4, 5, 6, 7 or 8 carbon atoms and accordingly is preferably ethyl, propyl, butyl, pentyl, hexyl, heptyl, octyl, ethoxy, propoxy, butoxy, pentoxy, hexoxy, heptoxy, or octoxy, furthermore methyl, nonyl, decyl, undecyl, dodecyl, tridecyl, tetradecyl, pentadecyl, methoxy, nonoxy, decoxy, undecoxy, dodecoxy, tridecoxy or tetradecoxy, for example.

Oxaalkyl, i.e. where one CH₂ group is replaced by —O—, is preferably straight-chain 2-oxapropyl (=methoxymethyl), 2-(=ethoxymethyl) or 3-oxabutyl (=2-methoxyethyl), 2-, 3-, or 4-oxapentyl, 2-, 3—, 4-, or 5-oxahexyl, 2-, 3—, 4-, 5-, or 6-oxaheptyl, 2-, 3—, 4-, 5-, 6- or 7-oxaoctyl, 2-, 3—, 4-, 5-, 6-, 7- or 8-oxanonyl or 2-, 3—, 4-, 5-, 6-, 7-, 8- or 9-oxadecyl, for example.

L and S are preferably F, Cl, CN, NO₂, CH₃, C₂H₅, OCH₃, OC₂H₅, COCH₃, COC₂H₅, CF₃, OCF₃, in particular F, Cl, CN, CH₃, C₂H₅, OCH₃, COCH₃ and OCF₃, most preferably F, CH₃, OCH₃ and COCH₃.

In the compounds of formula I P is CH₂═CW—COO—, WCH═CH—O— or CH₂═CH-Phenyl-(O)ₖ— with W being H, CH₃ or C₁ and k being 0 or 1.

P is preferably a vinyl group, an acrylate group, a methacrylate group, a propenyl ether group or an epoxy group, especially preferably an acrylate or a methacrylate group.

As for the spacer group Sp all groups can be used that are known for this purpose to the skilled in the art. The spacer group Sp is preferably linked to the polymerisable group P by an ester or ether group or a single bond. The spacer group Sp is preferably a linear or branched alkylene group having 1 to 20 C atoms, in particular 1 to 12 C atoms, in which, in addition, one or more non-adjacent CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—.

Typical spacer groups are for example —(CH₂)ₒ—, —(CH₂CH₂O)ᵣ—, —CH₂CH₂—, —CH₂CH₂—S—CH₂CH₂— or —CH₂CH₂—NH—CH₂CH₂—, with o being an integer from 2 to 12 and r being an integer from 1 to 3.

Preferred spacer groups are ethylene, propylene, butylene, pentylene, hexylene, heptylene, octylene, nonylene, decylene, undecylene, dodecylene, octadecylene, ethyleneoxyethylene, methyleneoxybutylene, ethylene-thioethylene, ethylene-N-methyl-iminoethylene and 1-methylalkylene, for example.

In particular preferred are compounds of formula I wherein n is 1.

In a preferred embodiment, the polymers are copolymers obtained by copolymerising mixtures comprising compounds of formula I wherein n is 0 and compounds of formula I wherein n is 1.

In the event that R or Q² is a group of formula P-Sp-X— or P-Sp- respectively, the spacer groups on each side of the mesogenic core may be identical or different.

The chiral photoreactive compounds of formula I can be prepared for example according to or in analogy to the method described in GB 2 314 839 B.

Preferably the proportion of the chiral compounds without a photoreactive group, especially those selected from formulae C-I, C-II, C-III, CRMa, CRMb and CRMc or their subformulae and R/S-5011, in the polymerisable liquid-crystalline medium according to the present invention as a whole is in the range from 0.05 to 2% by weight, very preferably in the range from 0.1 to 1% by weight, most preferably in the range from 0.1 to 0.5% by weight.

Preferably the proportion of the chiral compounds with a photoreactive group, especially those selected from formula I or its subformulae, in the polymerisable liquid-crystalline medium according to the present invention as a whole is in the range from 0.05 to 1% by weight, very preferably in the range from 0.1 to 0.8% by weight, most preferably in the range from 0.1 to 0.4% by weight.

Preferably the proportion of the chiral compounds without a photoreactive group in the polymerisable liquid-crystalline medium according to the present invention as a whole is smaller than the proportion of the chiral compounds with a photoreactive group in the polymerisable liquid-crystalline medium according to the present invention as a whole. Further preferably, in the polymerisable liquid-crystalline medium according to the present invention the weight % ratio of the chiral compounds with a photoreactive group to the chiral compounds without a photoreactive group is from 2:1 to 1:1, more preferably from 1.8:1 to 1.4:1, most preferably from 1.7:1 to 1.5:1.

In a further preferred embodiment the polymerisable LC medium optionally comprises one or more additives selected from the group consisting of further polymerisation initiators, antioxidants, surfactants, stabilisers, catalysts, sensitizers, inhibitors, chain-transfer agents, co-reacting monomers, reactive thinners, surface-active compounds, lubricating agents, wetting agents, dispersing agents, hydrophobing agents, adhesive agents, flow improvers, degassing or defoaming agents, deaerators, diluents, reactive diluents, auxiliaries, colourants, dyes, pigments and nanoparticles.

In another preferred embodiment, the polymerisable LC medium optionally comprises one or more additives selected from polymerisable non-mesogenic compounds (reactive thinners). The amount of these additives in the polymerisable LC medium is preferably from 0 to 30%, very preferably from 0 to 25%.

The reactive thinners used are not only substances which are referred to in the actual sense as reactive thinners, but also auxiliary compounds already mentioned above which contain one or more complementary reactive units or polymerisable groups P, for example hydroxyl, thiol-, or amino groups, via which a reaction with the polymerisable units of the liquid-crystalline compounds can take place.

The substances, which are usually capable of photopolymerisation, include, for example, mono-, bi- and polyfunctional compounds containing at least one olefinic double bond. Examples thereof are vinyl esters of carboxylic acids, for example of lauric, myristic, palmitic and stearic acid, and of dicarboxylic acids, for example of succinic acid, adipic acid, allyl and vinyl ethers and methacrylic and acrylic esters of monofunctional alcohols, for example of lauryl, myristyl, palmityl and stearyl alcohol, and diallyl and divinyl ethers of bifunctional alcohols, for example ethylene glycol and 1,4-butanediol.

Also suitable are, for example, methacrylic and acrylic esters of polyfunctional alcohols, in particular those which contain no further functional groups, or at most ether groups, besides the hydroxyl groups. Examples of such alcohols are bifunctional alcohols, such as ethylene glycol, propylene glycol and their more highly condensed representatives, for example diethylene glycol, triethylene glycol, dipropylene glycol, tripropylene glycol etc., butanediol, pentanediol, hexanediol, neopentyl glycol, alkoxylated phenolic compounds, such as ethoxylated and propoxylated bisphenols, cyclohexanedimethanol, trifunctional and polyfunctional alcohols, such as glycerol, trimethylolpropane, butanetriol, trimethylolethane, pentaerythritol, ditrimethylolpropane, dipentaerythritol, sorbitol, mannitol, and the corresponding alkoxylated, in particular ethoxylated and propoxylated alcohols.

Other suitable reactive thinners are polyester (meth)acrylates, which are the (meth)acrylic ester of polyesterols.

Examples of suitable polyesterols are those which can be prepared by esterification of polycarboxylic acids, preferably dicarboxylic acids, using polyols, preferably diols. The starting materials for such hydroxyl-containing polyesters are known to the person skilled in the art. Dicarboxylic acids which can be employed are succinic, glutaric acid, adipic acid, sebacic acid, o-phthalic acid and isomers and hydrogenation products thereof, and esterifiable and transesterifiable derivatives of said acids, for example anhydrides and dialkyl esters. Suitable polyols are the abovementioned alcohols, preferably ethyleneglycol, 1,2- and 1,3-propylene glycol, 1,4-butanediol, 1,6-hexanediol, neopentyl glycol, cyclohexanedimethanol and polyglycols of the ethylene glycol and propylene glycol type.

Suitable reactive thinners are furthermore 1,4-divinylbenzene, triallyl cyanurate, acrylic esters of tricyclodecenyl alcohol also known under the name dihydrodicyclopentadienyl acrylate, and the allyl esters of acrylic acid, methacrylic acid and cyanoacrylic acid.

Of the reactive thinners, which are mentioned by way of example, those containing photopolymerisable groups are used in particular and in view of the abovementioned preferred compositions.

This group includes, for example, dihydric and polyhydric alcohols, for example ethylene glycol, propylene glycol and more highly condensed representatives thereof, for example diethylene glycol, triethylene glycol, dipropylene glycol, tripropylene glycol etc., butanediol, pentanediol, hexanediol, neopentyl glycol, cyclohexanedimethanol, glycerol, trimethylolpropane, butanetriol, trimethylolethane, pentaerythritol, ditrimethylolpropane, dipentaerythritol, sorbitol, mannitol and the corresponding alkoxylated, in particular ethoxylated and propoxylated alcohols.

The group furthermore also includes, for example, alkoxylated phenolic compounds, for example ethoxylated and propoxylated bisphenols.

These reactive thinners may furthermore be, for example, epoxide or urethane (meth)acrylates.

Epoxide (meth)acrylates are, for example, those as obtainable by the reaction, known to the person skilled in the art, of epoxidized olefins or poly- or diglycidyl ether, such as bisphenol A diglycidyl ether, with (meth)acrylic acid.

Urethane (meth)acrylates are, in particular, the products of a reaction, likewise known to the person skilled in the art, of hydroxylalkyl (meth)acrylates with poly- or diisocyanates.

Such epoxide and urethane (meth)acrylates are included amongst the compounds listed above as “mixed forms”.

If reactive thinners are used, their amount and properties must be matched to the respective conditions in such a way that, on the one hand, a satisfactory desired effect, for example the desired colour of the composition according to the invention, is achieved, but, on the other hand, the phase behaviour of the liquid-crystalline composition is not excessively impaired. The low-crosslinking (high-crosslinking) liquid-crystalline compositions can be prepared, for example, using corresponding reactive thinners, which have a relatively low (high) number of reactive units per molecule.

The group of diluents include, for example:
C1-C4-alcohols, for example methanol, ethanol, n-propanol, isopropanol, butanol, isobutanol, sec-butanol and, in particular, the C5-C12-alcohols n-pentanol, n-hexanol, n-heptanol, n-octanol, n-nonanol, n-decanol, n-undecanol and n-dodecanol, and isomers thereof, glycols, for example 1,2-ethylene glycol, 1,2- and 1,3-propylene glycol, 1,2-, 2,3- and 1,4-butylene glycol, di- and triethylene glycol and di- and tripropylene glycol, ethers, for example methyl tert-butyl ether, 1,2-ethylene glycol mono- and dimethyl ether, 1,2-ethylene glycol mono- and -diethylether, 3-methoxypropanol, 3-isopropoxypropanol, tetrahydrofuran and dioxane, ketones, for example acetone, methyl ethyl ketone, methyl isobutyl ketone and diacetone alcohol (4-hydroxy-4-methyl-2-pentanone), C1-C5-alkyl esters, for example methyl acetate, ethyl acetate, propyl acetate, butyl acetate and amyl acetate, aliphatic and aromatic hydrocarbons, for example pentane, hexane, heptane, octane, isooctane, petroleum ether, toluene, xylene, ethylbenzene, tetralin, decalin, dimethylnaphthalene, white spirit, Shellsol® and Solvesso® mineral oils, for example gasoline, kerosine, diesel oil and heating oil, but also natural oils, for example olive oil, soya oil, rapeseed oil, linseed oil and sunflower oil.

It is of course also possible to use mixtures of these diluents in the compositions according to the invention.

So long as there is at least partial miscibility, these diluents can also be mixed with water. Examples of suitable diluents here are C1-C4-alcohols, for example methanol, ethanol, n-propanol, isopropanol, butanol, isobutanol and sec-butanol, glycols, for example 1,2-ethylene glycol, 1,2- and 1,3-propylene glycol, 1,2-, 2,3- and 1,4-butylene glycol, di- and triethylene glycol, and di- and tripropylene glycol, ethers, for example tetrahydrofuran and dioxane, ketones, for example acetone, methyl ethyl ketone and diacetone alcohol (4-hydroxy-4-methyl-2-pentanone), and C1-C4-alkyl esters, for example methyl, ethyl, propyl and butyl acetate.

The diluents are optionally employed in a proportion of from about 0 to 10.0% by weight, preferably from about 0 to 5.0% by weight, based on the total weight of the polymerisable LC medium.

The antifoams and deaerators (c1)), lubricants and flow auxiliaries (c2)), thermally curing or radiation-curing auxiliaries (c3)), substrate wetting auxiliaries (c4)), wetting and dispersion auxiliaries (c5)), hydrophobicizing agents (c6)), adhesion promoters (c7)) and auxiliaries for promoting scratch resistance (c8)) cannot strictly be delimited from one another in their action.

For example, lubricants and flow auxiliaries often also act as antifoams and/or deaerators and/or as auxiliaries for improving scratch resistance. Radiation-curing auxiliaries can also act as lubricants and flow auxiliaries and/or deaerators and/or as substrate wetting auxiliaries. In individual cases, some of these auxiliaries can also fulfil the function of an adhesion promoter (c8)).

Corresponding to the above-said, a certain additive can therefore be classified in a number of the groups c1) to c8) described below.

The antifoams in group c1) include silicon-free and silicon-containing polymers. The silicon-containing polymers are, for example, unmodified or modified polydialkylsiloxanes or branched copolymers, comb or block copolymers comprising polydialkylsiloxane and polyether units, the latter being obtainable from ethylene oxide or propylene oxide.

The deaerators in group c1) include, for example, organic polymers, for example polyethers and polyacrylates, dialkylpolysiloxanes, in particular dimethylpolysiloxanes, organically modified polysiloxanes, for example arylalkyl-modified polysiloxanes, and fluorosilicones.

The action of the antifoams is essentially based on preventing foam formation or destroying foam that has already formed. Antifoams essentially work by promoting coalescence of finely divided gas or air bubbles to give larger bubbles in the medium to be deaerated, for example the compositions according to the invention, and thus accelerate escape of the gas (of the air). Since antifoams can frequently also be employed as deaerators and vice versa, these additives have been included together under group c1).

Such auxiliaries are, for example, commercially available from Tego as TEGO® Foamex 800, TEGO® Foamex 805, TEGO® Foamex 810, TEGO® Foamex 815, TEGO® Foamex 825, TEGO® Foamex 835, TEGO® Foamex 840, TEGO® Foamex 842, TEGO® Foamex 1435, TEGO® Foamex 1488, TEGO® Foamex 1495, TEGO® Foamex 3062, TEGO® Foamex 7447, TEGO® Foamex 8020, Tego® Foamex N, TEGO® Foamex K 3, TEGO® Antifoam 2-18, TEGO® Antifoam 2-18, TEGO® Antifoam 2-57, TEGO® Antifoam 2-80, TEGO® Antifoam 2-82, TEGO® Antifoam 2-89, TEGO® Antifoam 2-92, TEGO® Antifoam 14, TEGO® Antifoam 28, TEGO® Antifoam 81, TEGO® Antifoam D 90, TEGO® Antifoam 93, TEGO® Antifoam 200, TEGO® Antifoam 201, TEGO® Antifoam 202, TEGO® Antifoam 793, TEGO® Antifoam 1488, TEGO® Antifoam 3062, TEGOPREN® 5803, TEGOPREN® 5852, TEGOPREN® 5863, TEGOPREN® 7008, TEGO® Antifoam 1-60, TEGO® Antifoam 1-62, TEGO® Antifoam 1-85, TEGO® Antifoam 2-67, TEGO® Antifoam WM 20, TEGO® Antifoam 50, TEGO® Antifoam 105, TEGO® Antifoam 730, TEGO® Antifoam MR 1015, TEGO® Antifoam MR 1016, TEGO® Antifoam 1435, TEGO® Antifoam N, TEGO® Antifoam KS 6, TEGO® Antifoam KS 10, TEGO® Antifoam KS 53, TEGO® Antifoam KS 95, TEGO® Antifoam KS 100, TEGO® Antifoam KE 600, TEGO® Antifoam KS 911, TEGO® Antifoam MR 1000, TEGO® Antifoam KS 1100, Tego® Airex 900, Tego® Airex 910, Tego® Airex 931, Tego® Airex 935, Tego® Airex 936, Tego® Airex 960, Tego® Airex 970, Tego® Airex 980 and Tego® Airex 985 and from BYK as BYK®-011, BYK®-019, BYK®-020, BYK®-021, BYK®-022, BYK®-023, BYK®-024, BYK®-025, BYK®-027, BYK®-031, BYK®-032, BYK®-033, BYK®-034, BYK®-035, BYK®-036, BYK®-037, BYK®-045, BYK®-051, BYK®-052, BYK®-053, BYK®-055, BYK®-057, BYK®-065, BYK®-066, BYK®-070, BYK®-080, BYK®-088, BYK®-141 and BYK®-A 530.

The auxiliaries in group c1) are optionally employed in a proportion of from about 0 to 3.0% by weight, preferably from about 0 to 2.0% by weight, based on the total weight of the polymerisable LC medium.

In group c2), the lubricants and flow auxiliaries typically include silicon-free, but also silicon-containing polymers, for example polyacrylates or modifiers, low-molecular-weight polydialkylsiloxanes. The modification consists in some of the alkyl groups having been replaced by a wide variety of organic radicals. These organic radicals are, for example, polyethers, polyesters or even long-chain (fluorinated)alkyl radicals, the former being used the most frequently.

The polyether radicals in the correspondingly modified polysiloxanes are usually built up from ethylene oxide and/or propylene oxide units. Generally, the higher the proportion of these alkylene oxide units in the modified polysiloxane, the more hydrophilic is the resultant product.

Such auxiliaries are, for example, commercially available from Tego as TEGO® Glide 100, TEGO® Glide ZG 400, TEGO® Glide 406, TEGO® Glide 410, TEGO® Glide 411, TEGO® Glide 415, TEGO® Glide 420, TEGO® Glide 435, TEGO® Glide 440, TEGO® Glide 450, TEGO® Glide A 115, TEGO® Glide B 1484 (can also be used as antifoam and deaerator), TEGO® Flow ATF, TEGO® Flow 300, TEGO® Flow 460, TEGO® Flow 425 and TEGO® Flow ZFS 460. Suitable radiation-curable lubricants and flow auxiliaries, which can also be used to improve the scratch resistance, are the products TEGO® Rad 2100, TEGO® Rad 2200, TEGO® Rad 2500, TEGO® Rad 2600 and TEGO® Rad 2700, which are likewise obtainable from TEGO.

Such-auxiliaries are also available, for example, from BYK as BYK®-300 BYK®-306, BYK®-307, BYK®-310, BYK®-320, BYK®-333, BYK®-341, Byk® 354, Byk®361, Byk®361 N, BYK® 388.

Such-auxiliaries are also available, for example, from 3M as FC4430®.

Such-auxiliaries are also available, for example, from Cytonix as FluorN®561 or FluorN®562.

Such-auxiliaries are also available, for example, from Merck KGaA as Tivida® FL 2300 and Tivida® FL 2500

The auxiliaries in group c2) are optionally employed in a proportion of from about 0 to 3.0% by weight, preferably from about 0 to 2.0% by weight, based on the total weight of the polymerisable LC medium.

In group c3), the radiation-curing auxiliaries include, in particular, polysiloxanes having terminal double bonds which are, for example, a constituent of an acrylate group. Such auxiliaries can be crosslinked by actinic or, for example, electron radiation. These auxiliaries generally combine a number of properties together. In the uncrosslinked state, they can act as antifoams, deaerators, lubricants and flow auxiliaries and/or substrate wetting auxiliaries, while, in the crosslinked state, they increase, in particular, the scratch resistance, for example of coatings or films which can be produced using the compositions according to the invention. The improvement in the gloss properties, for example of precisely those coatings or films, is regarded essentially as a consequence of the action of these auxiliaries as antifoams, deaerators and/or lubricants and flow auxiliaries (in the uncrosslinked state).

Examples of suitable radiation-curing auxiliaries are the products TEGO® Rad 2100, TEGO® Rad 2200, TEGO® Rad 2500, TEGO® Rad 2600 and TEGO® Rad 2700 available from TEGO and the product BYK®-371 available from BYK.

Thermally curing auxiliaries in group c3) contain, for example, primary OH groups, which are able to react with isocyanate groups, for example of the binder.

Examples of thermally curing auxiliaries, which can be used, are the products BYK®-370, BYK®-373 and BYK®-375 available from BYK.

The auxiliaries in group c3) are optionally employed in a proportion of from about 0 to 5.0% by weight, preferably from about 0 to 3.0% by weight, based on the total weight of the polymerisable LC medium.

The substrate wetting auxiliaries in group c4) serve, in particular, to increase the wettability of the substrate to be printed or coated, for example, by printing inks or coating compositions, for example compositions according to the invention. The generally attendant improvement in the lubricant and flow behaviour of such printing inks or coating compositions has an effect on the appearance of the finished (for example crosslinked) print or coating.

A wide variety of such auxiliaries are commercially available, for example from Tego as TEGO® Wet KL 245, TEGO® Wet 250, TEGO® Wet 260 and TEGO® Wet ZFS 453 and from BYK as BYK®-306, BYK®-307, BYK®-310, BYK®-333, BYK®-344, BYK®-345, BYK®-346 and Byk®-348.

The auxiliaries in group c4) are optionally employed in a proportion of from about 0 to 3.0% by weight, preferably from about 0 to 1.5% by weight, based on the total weight of the liquid-crystalline composition.

The wetting and dispersion auxiliaries in group c5) serve, in particular, to prevent the flooding and floating and the sedimentation of pigments and are therefore, if necessary, suitable in particular in pigmented compositions.

These auxiliaries stabilize pigment dispersions essentially through electrostatic repulsion and/or steric hindrance of the pigment particles containing these additives, where, in the latter case, the interaction of the auxiliary with the ambient medium (for example binder) plays a major role.

Since the use of such wetting and dispersion auxiliaries is common practice, for example in the technical area of printing inks and paints, the selection of a suitable auxiliary of this type generally does not present the person skilled in the art with any difficulties, if they are used.

Such wetting and dispersion auxiliaries are commercially available, for example from Tego, as TEGO® Dispers 610, TEGO® Dispers 610 S, TEGO® Dispers 630, TEGO® Dispers 700, TEGO® Dispers 705, TEGO® Dispers 710, TEGO® Dispers 720 W, TEGO® Dispers 725 W, TEGO® Dispers 730 W, TEGO® Dispers 735 W and TEGO® Dispers 740 W and from BYK as Disperbyk®, Disperbyk®-107, Disperbyk®-108, Disperbyk®-110, Disperbyk®-111, Disperbyk®-115, Disperbyk®-130, Disperbyk®-160, Disperbyk®-161, Disperbyk®-162, Disperbyk®-163, Disperbyk®-164, Disperbyk®-165, Disperbyk®-166, Disperbyk®-167, Disperbyk®-170, Disperbyk®-174, Disperbyk®-180, Disperbyk®-181, Disperbyk®-182, Disperbyk®-183, Disperbyk®-184, Disperbyk®-185, Disperbyk®-190, Anti-Terra®-U, Anti-Terra®-U 80, Anti-Terra®-P, Anti-Terra®-203, Anti-Terra®-204, Anti-Terra®-206, BYK®-151, BYK®-154, BYK®-155, BYK®-P 104 S, BYK®-P 105, Lactimon®, Lactimon®-WS and Bykumen®.

The amount of the auxiliaries in group c5) used on the mean molecular weight of the auxiliary. In any case, a preliminary experiment is therefore advisable, but this can be accomplished simply by the person skilled in the art.

The hydrophobicizing agents in group c6) can be used to give water-repellent properties to prints or coatings produced, for example, using compositions according to the invention. This prevents or at least greatly suppresses swelling due to water absorption and thus a change in, for example, the optical properties of such prints or coatings. In addition, when the composition is used, for example, as a printing ink in offset printing, water absorption can thereby be prevented or at least greatly reduced.

Such hydrophobicizing agents are commercially available, for example, from Tego as Tego® Phobe WF, Tego® Phobe 1000, Tego® Phobe 1000 S, Tego® Phobe 1010, Tego® Phobe 1030, Tego® Phobe 1010, Tego® Phobe 1010, Tego® Phobe 1030, Tego® Phobe 1040, Tego® Phobe 1050, Tego® Phobe 1200, Tego® Phobe 1300, Tego® Phobe 1310 and Tego® Phobe 1400.

The auxiliaries in group c6) are optionally employed in a proportion of from about 0 to 5.0% by weight, preferably from about 0 to 3.0% by weight, based on the total weight of the polymerisable LC medium.

Further adhesion promoters from group c7) serve to improve the adhesion of two interfaces in contact. It is directly evident from this that essentially the only fraction of the adhesion promoter that is effective is that located at one or the other or at both interfaces. If, for example, it is desired to apply liquid or pasty printing inks, coating compositions or paints to a solid substrate, this generally means that the adhesion promoter must be added directly to the latter or the substrate must be pre-treated with the adhesion promoters (also known as priming), i.e. this substrate is given modified chemical and/or physical surface properties.

If the substrate has previously been primed with a primer, this means that the interfaces in contact are that of the primer on the one hand and of the printing ink or coating composition or paint on the other hand. In this case, not only the adhesion properties between the substrate and the primer, but also between the substrate and the printing ink or coating composition or paint play a part in adhesion of the overall multilayer structure on the substrate.

Adhesion promoters in the broader sense which may be mentioned are also the substrate wetting auxiliaries already listed under group c4), but these generally do not have the same adhesion promotion capacity.

In view of the widely varying physical and chemical natures of substrates and of printing inks, coating compositions and paints intended, for example, for their printing or coating, the multiplicity of adhesion promoter systems is not surprising.

Adhesion promoters based on silanes are, for example, 3-aminopropyltrimethoxysilane, 3-aminopropyltriethoxysilane, 3-aminopropylmethyldiethoxysilane, N-aminoethyl-3-aminopropyltrimethoxysilane, N-aminoethyl-3-aminopropylmethyldimethoxysilane, N-methyl-3-aminopropyltrimethoxysilane, 3-ureidopropyltriethoxysilane, 3-methacryloyloxypropyltrimethoxysilane, 3-glycidyloxypropyltrimethoxysilane, 3-mercaptopropyltrimethoxysilane, 3-chloropropyltrimethoxysilane and vinyltrimethoxysilane. These and other silanes are commercially available from Hüls, for example under the tradename DYNASILAN®.

Corresponding technical information from the manufacturers of such additives should generally be used or the person skilled in the art can obtain this information in a simple manner through corresponding preliminary experiments.

However, if these additives are to be added as auxiliaries from group c7) to the polymerisable LC mediums according to the invention, their proportion optionally corresponds to from about 0 to 5.0% by weight, based on the total weight of the polymerisable LC medium. These concentration data serve merely as guidance, since the amount and identity of the additive are determined in each individual case by the nature of the substrate and of the printing/coating composition. Corresponding technical information is usually available from the manufacturers of such additives for this case or can be determined in a simple manner by the person skilled in the art through corresponding preliminary experiments.

The auxiliaries for improving the scratch resistance in group c8) include, for example, the abovementioned products TEGO® Rad 2100, TEGO® Rad 2200, TEGO® Rad 2500, TEGO® Rad 2600 and TEGO® Rad 2700, which are available from Tego.

For these auxiliaries, the amount data given for group c3) are likewise suitable, i.e. these additives are optionally employed in a proportion of from about 0 to 5.0% by weight, preferably from about 0 to 3.0% by weight, based on the total weight of the liquid-crystalline composition.

Examples that may be mentioned of further light, heat and/or oxidation stabilizers are the following:
alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which have a linear or branched side chain, for example 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures of these compounds, alkylthiomethylphenols, such as 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol,
Hydroquinones and alkylated hydroquinones, such as 2,6-di-tert-butyl-4-methoxyphenol, 2,5-di-tert-butylhydroquinone, 2,5-di-tert-amylhydrocrainone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate and bis(3,5-di-tert-butyl-4-hydroxyphenyl)adipate,
Tocopherols, such as α-tocopherol, β-tocopherol, γ-tocopherol, δ-tocopherol and mixtures of these compounds, and tocopherol derivatives, such as tocopheryl acetate, succinate, nicotinate and polyoxyethylenesuccinate (“tocofersolate”),
hydroxylated diphenyl thioethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol) and 4,4′-bis(2,6-dimethyl-4-hydroxyphenyl)disulfide,
Alkylidenebisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecyl-mercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecyl-mercaptobutane and 1,1,5,5-tetrakis(5-tert-butyl-4-hydroxy-2-methylphenyl)pentane,
O—, N- and S-benzyl compounds, such as 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide and isooctyl-3,5-di-tert-butyl-4-hydroxybenzylmercaptoacetate,
aromatic hydroxybenzyl compounds, such as 1,3,5-tris(3,5-di-tert-butyl-4-hydroxybenzyl)-2,4,6-trimethyl-benzene, 1,4-bis(3,5-di-tert-butyl-4-hydroxybenzyl)-2,3,5,6-tetramethyl-benzene and 2,4,6-tris(3,5-di-tert-butyl-4-hydroxybenzyl)phenol,
Triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris-(3,5-di-tert-butyl-4-hydroxyphenylpropionyl)hexahydro-1,3,5-triazine, 1,3,5-tris(3,5-dicyclohexyl-4-hydroxybenzyl)isocyanurate and 1,3,5-tris(2-hydroxyethyl)isocyanurate,
Benzylphosphonates, such as dimethyl 2,5-di-tert-butyl-4-hydroxybenzylphosphonate, diethyl 3,5-di-tert-butyl-4-hydroxybenzylphosphonate, dioctadecyl 3,5-di-tert-butyl-4-hydroxybenzylphosphonate and dioctadecyl 5-tert-butyl-4-hydroxy-3-methylbenzylphosphonate,
Acylaminophenols, such as 4-hydroxylauroylanilide, 4-hydroxystearoylanilide and octyl N-(3,5-di-tert-butyl-4-hydroxyphenyl)carbamate,
Propionic and acetic esters, for example of monohydric or polyhydric alcohols, such as methanol, ethanol, n-octanol, i-octanol, octadecanol, 1.6-hexanediol, 1.9-nonanediol, ethylene glycol, 1.2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane and 4-hydroxymethyl-1-phospha-2,6,7-trioxabicyclo[2.2.2]-octane,
Propionamides based on amine derivatives, such as N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine and N,N′-bis(3,5-di-tert-butyl-4-hydroxyphenylpropionyl)hydrazine,
Ascorbic acid (Vitamin C) and ascorbic acid derivatives, such as ascorbyl palmitate, laurate and stearate, and ascorbyl sulfate and phosphate,
Antioxidants based on amine compounds, such as N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octyl-substituted diphenylamine, such as p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis[4-methoxyphenyl)amine, 2,6-di-tert-butyl-4-dimethylaminomethylphenol, 2,4-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octyl-substituted N-phenyl-1-naphthylamine, a mixture of mono- and dialkylated tert-butyl/tert-octyldiphenylamine, a mixture of mono- and dialkylated nonyldiphenylamine, a mixture of mono- and dialkylated dodecyldiphenylamine, a mixture of mono- and dialkylated isopropyl/isohexyldiphenylamine, a mixture of mono- and dialkylated tert-butyldiphenylamine, 2,3-dihydro-3,3-dimethyl-4H-1,4-benzothiazine, phenothiazine, a mixture of mono- and dialkylated tert-butyl/tert-octylphenothiazine, a mixture of mono- and dialkylated tert-octylphenothiazine, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl)sebacate, 2,2,6,6-tetramethylpiperidin-4-one and 2,2,6,6-tetramethylpiperidin-4-ol,
Phosphines, Phosphites and phosphonites, such as triphenylphosnine triphenylphosphite, diphenyl alkyl phosphite, phenyl dialkyl phosphite, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, diisodecyloxy pentaerythritol diphosphite, bis(2,4-di-tert-butyl-6-methylphenyl)pentaerythritol diphosphite, bis(2,4,6-tris(tert-butylphenyl))pentaerythritol diphosphite, tristearyl sorbitol triphosphite, tetrakis(2,4-di-tert-butylphenyl)4,4′-biphenylenediphosphonite, 6-isooctyloxy-2,4,8,10-tetra-tert-butyl-12H-dibenz[d,g]-1,3,2-dioxaphosphocine, 6-fluoro-2,4,8,10-tetra-tert-butyl-12-methyl-dibenz[d,g]-1,3,2-dioxaphosphocine, bis(2,4-di-tert-butyl-6-methylphenyl)methyl phosphite and bis(2,4-di-tert-butyl-6-methylphenyl)ethyl phosphite,
2-(2′-Hydroxyphenyl)benzotriazoles, such as 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3,5′-bis-(α,α-dimethylbenzyl)-2′-hydroxyphenyl)benzotriazole, a mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxy phenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxy phenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenyl benzotriazole, 2,2′-methylenebis[4-(1,1,3,3-tetramethylbutyl)-6-benzotriazol-2-ylphenol]; the product of complete esterification of 2-[3′-tert-butyl-5′-(2-methoxycarbonylethyl)-2′-hydroxyphenyl]-2H-benzotriazole with polyethylene glycol 300;
sulfur-containing peroxide scavengers and sulfur-containing antioxidants, such as esters of 3,3′-thiodipropionic acid, for example the lauryl, stearyl, myristyl and tridecyl esters, mercaptobenzimidazole and the zinc salt of 2-mercaptobenzimidazole, dibutylzinc dithiocarbamates, dioctadecyl disulfide and pentaerythritol tetrakis(β-dodecylmercapto)propionate,
2-hydroxybenzophenones, such as the 4-hydroxy, 4-methoxy, 4-octyloxy, 4-decycloxy, 4-dodecyloxy, 4-benzyloxy, 4,2′,4′-trihydroxy and 2′-hydroxy-4,4′-dimethoxy derivatives,
Esters of unsubstituted and substituted benzoic acids, such as 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl-3,5-di-tert-butyl-4-hydroxybenzoate, octadecyl-3,5-di-tert-butyl-4-hydroxybenzoate and 2-methyl-4,6-di-tert-butylphenyl-3,5-di-tert-butyl-4-hydroxybenzoate,
Acrylates, such as ethyl α-cyano-β,β-diphenylacrylate, isooctyl α-cyano-β,β-diphenylacrylate, methyl α-methoxycarbonylcinnamate, methyl α-cyano-β-methyl-p-methoxycinnamate, butyl-α-cyano-β-methyl-p-methoxycinnamate and methyl-α-methoxycarbonyl-p-methoxycinnamate, sterically hindered amines, such as bis(2,2,6,6-tetramethylpiperidin-4-yl)sebacate, bis(2,2,6,6-tetramethylpiperidin-4-yl)succinate, bis(1,2,2,6,6-pentamethylpiperidin-4-yl)sebacate, bis(1-octyloxy-2,2,6,6-tetramethylpiperidin-4-yl)sebacate, bis(1,2,2,6,6-pentamethylpiperidin-4-yl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, the condensation product of N,N′-bis(2,2,6,6-tetramethylpiperidin-4-yl)hexamethylenediamine and 4-tert-octylamino-2,6-dichloro-1,3,5-triazine, tris(2,2,6,6-tetramethylpiperidin-4-yl)nitrilotriacetate, tetrakis(2,2,6,6-tetramethylpiperidin-4-yl)1,2,3,4-butanetetracarboxylate, 1,1′-(1,2-ethylene)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidin-4-yl)2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidin-4-yl)sebacate, bis(1-octyloxy-2,2,6,6-tetramethylpiperidin-4-yl)succinate, the condensation product of N,N′-bis(2,2,6,6-tetramethylpiperidin-4-yl)hexamethylenediamine and 4-morpholino-2,6-dichloro-1,3,5-triazine, the condensation product of 2-chloro-4,6-bis(4-n-butylamino-2,2,6,6-tetramethylpiperidin-4-yl)-1,3,5-triazine and 1,2-bis(3-aminopropylamino)ethane, the condensation product of 2-chloro-4,6-di(4-n-butylamino-1,2,2,6,6-pentamethylpiperidin-4-yl)-1,3,5-triazine and 1,2-bis(3-aminopropylamino)ethane, 8-acetyl-3-dodecyl-7,7,9,9-tetramethyl-1,3,8-triazaspiro[4.5]-decane-2,4-dione, 3-dodecyl-1-(2,2,6,6-tetramethylpiperidin-4-yl)pyrrolidine-2,5-dione, 3-dodecyl-1-(1,2,2,6,6-pentamethylpiperidin-4-yl)pyrrolidine-2,5-dione, a mixture of 4-hexadecyloxy- and 4-stearyloxy-2,2,6,6-tetramethylpiperidine, the condensation product of N,N′-bis(2,2,6,6-tetramethylpiperidin-4-yl)hexamethylenediamine and 4-cyclohexylamino-2,6-dichloro-1,3,5-triazine, the condensation product of 1,2-bis(3-aminopropylamino)ethane and 2,4,6-trichloro-1,3,5-triazine, 4-butylamino-2,2,6,6-tetramethylpiperidine, N-(2,2,6,6-tetramethylpiperidin-4-yl)-n-dodecylsuccinimide, N-(1,2,2,6,6-pentamethylpiperidin-4-yl)-n-dodecylsuccinimide, 2-undecyl-7,7,9,9-tetramethyl-1-oxa-3,8-diaza-4-oxospiro[4.5]-decane, the condensation product of 7,7,9,9-tetramethyl-2-cycloundecyl-1-oxa-3,8-diaza-4-oxospiro-[4.5]decane and epichlorohydrin, the condensation products of 4-amino-2,2,6,6-tetramethylpiperidine with tetramethylolacetylenediureas and poly(methoxypropyl-3-oxy)-[4(2,2,6,6-tetramethyl)piperidinyl]-siloxane,
Oxalamides, such as 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxalamide, 2-ethoxy-5-tert-butyl-2′-ethoxanilide and its mixture with 2-ethoxy-2′-ethyl-5,4′-di-tert-butoxanilide, and mixtures of ortho-, para-methoxy-disubstituted oxanilides and mixtures of ortho- and para-ethoxy-disubstituted oxanilides, and
2-(2-hydroxyphenyl)-1,3,5-triazines, such as 2,4,6-tris-(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropoxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

In another preferred embodiment the polymerisable LC medium comprises one or more specific antioxidant additives, preferably selected from the Irganox® series, e.g. the commercially available antioxidants Irganox®1076 and Irganox®1010, from Ciba, Switzerland.

In another preferred embodiment, the polymerisable LC medium comprises one or more, more preferably two or more photoinitiators, for example, selected from the commercially available Irgacure® or Darocure® (Ciba AG) series, in particular, Irgacure 127, Irgacure 184, Irgacure 369, Irgacure 651, Irgacure 817, Irgacure 907, Irgacure 1300, Irgacure, Irgacure 2022, Irgacure 2100, Irgacure 2959, or Darcure TPO. Especially the polymerisable LC medium comprises preferably one or more oxime ester photoinitiators preferably selected from the commercially available OXE02 (Ciba AG), NCI 930, N1919T (Adeka), SPI-03 or SPI-04 (Samyang).

The concentration of the polymerisation initiator(s) as a whole in the polymerisable LC medium is preferably from 0.5 to 10%, very preferably from 0.8 to 8%, more preferably 1 to 6%.

Preferably, the polymerisable LC medium comprises a given ratio between the concentration of the photoinitiator and the concentration of all chiral compounds as a whole, which is in the range from 1:1 to 1:5, more preferably in the range from 1:1 to 1:4, even more preferably in the range from 1:1 to 1:3.

In a preferred embodiment the polymerisable LC medium is dissolved in a suitable solvent, which are preferably selected from organic solvents.

The solvents are preferably selected from ketones such as acetone, methyl ethyl ketone, methyl propyl ketone, methyl isobutyl ketone or cyclohexanone; acetates such as methyl, ethyl or butyl acetate or methyl acetoacetate; alcohols such as methanol, ethanol or isopropyl alcohol; aromatic solvents such as toluene or xylene; alicyclic hydrocarbons such as cyclopentane or cyclohexane; halogenated hydrocarbons such as di- or trichloromethane; glycols or their esters such as PGMEA (propyl glycol monomethyl ether acetate), Q-butyrolactone. It is also possible to use binary, ternary or higher mixtures of the above solvents.

In case the polymerisable LC medium contains one or more solvents, the total concentration of all solids, including the RMs, in the solvent(s) is preferably from 10 to 60%.

Preferably, the polymerisable LC medium comprises,
a) one or more di- or multireactive polymerisable mesogenic compounds,
b) optionally one or more monoreactive polymerisable mesogenic compounds, preferably selected from compounds of formula MRM1, MRM7, MRM9 and/or MRM10 and their corresponding subformulae,
c) one or more chiral mesogenic compounds in (S) configuration, preferably selected from compounds of formula CRMa, CRMb or CRMc, more preferably of formula CRMaa and its subformulae,
d) one or more photoreactive chiral mesogenic compounds in (R) configuration, preferably selected from compounds of formula I, very preferably from formula Ia,
e) optionally one or more antioxidative additives,
f) optionally one or more adhesion promotors,
g) optionally one or more surfactants,
h) optionally one or more mono-, di- or multireactive polymerisable non-mesogenic compounds,
i) optionally one or more dyes showing an absorption maximum at the wavelength used to initiate photo polymerisation,
j) optionally one or more chain transfer agents,
k) optionally one or more further stabilizers,
I) optionally one or more lubricants and flow auxiliaries, and
m) optionally one or more diluents,
n) optionally a non-polymerisable nematic component,
o) optionally one or more organic solvents.

Alternatively, the polymerisable LC medium comprises,
a) one or more di- or multireactive polymerisable mesogenic compounds,
b) optionally one or more monoreactive polymerisable mesogenic compounds, preferably selected from compounds of formula MRM1, MRM7, MRM9 and/or MRM10 and their corresponding subformulae,
c) one or more chiral mesogenic compounds in (R) configuration, preferably selected from compounds of formula CRMa, CRMb or CRMc, more preferably of formula CRMaa and its subformulae,
d) one or more photoreactive chiral mesogenic compounds in (S) configuration, preferably selected from compounds of formula I, very preferably from formula Ia,
e) optionally one or more antioxidative additives,
f) optionally one or more adhesion promotors,
g) optionally one or more surfactants,
h) optionally one or more mono-, di- or multireactive polymerisable non-mesogenic compounds,
i) optionally one or more dyes showing an absorption maximum at the wavelength used to initiate photo polymerisation,
j) optionally one or more chain transfer agents,
k) optionally one or more further stabilizers,
I) optionally one or more lubricants and flow auxiliaries, and
m) optionally one or more diluents,
n) optionally a non-polymerisable nematic component,
o) optionally one or more organic solvents.

The polymerisable LC medium according to the present invention are prepared in a manner conventional per se, for example by mixing one or more of the above-mentioned photoreactive chiral compounds with one or more direactive LC compounds and one or more chiral compounds, as defined above, and optionally with further additives.

The invention further relates to a process of preparing a polymer film comprising, preferably consisting of the steps of
providing a layer of a polymerisable LC medium as described above and below onto a substrate, which is optionally provided with an alignment layer capable of inducing a planar alignment to the adjacent layer of the polymerisable LC medium,
a first step of irradiation of the layer stack with actinic radiation, preferably with UV radiation, in air (1^{st} UV step), and
a seconds step of irradiation of the layer stack with actinic radiation, preferably with UV radiation, in an inert gas atmosphere (2^{nd} UV step).

The invention further relates to a polymer film obtainable by this process.

More preferably the process of preparing a polymer film according to the present invention comprises the following steps:
providing a layer of a polymerisable LC medium as described above and below, or a solution thereof, onto a substrate, which is preferably equipped with an alignment layer inducing planar alignment layer, for example a rubbed polyimide layer or a photo alignment layer, for example by spin-coating or printing methods, and optionally removing any solvents present,
exposing the layer of the polymerisable LC medium to UV light, which causes photoisomerisation of the chiral compound comprising the photoisomerisable group and provides the chiral structure with the biased helical pitch, preferably to unpolarised UV light, very preferably to unpolarised UVA light, for example with a dose of 40 to 500 mJ/cm², preferably in an air environment at ambient temperature (“1^{st} UV step”),
exposing the layer of the polymerisable LC medium to UV light, which causes photopolymerisation of the polymerisable mesogenic compounds, preferably to unpolarised UV light, very preferably to unpolarised UVA light, for example with a dose of 200 to 2000 mJ/cm² cm², preferably in an inert gas atmosphere, e.g. nitrogen and at ambient temperature (“2^{nd} UV step”).

Preferably in the process according to the present invention all irradiation or UV exposure steps are carried out at room temperature, and the layer of the polymerisable LC medium is not subjected to heat treatment during or between the irradiation or UV exposure steps.

The first irradiation or 1^{st} UV step causes photoisomerisation of the chiral compound comprising the photoisomerisable group and provides the chiral structure with the biased helical pitch. The second irradiation or 2^{nd} UV step causes photopolymerisation of the polymerisable mesgenic compounds and thereby fixes the chiral structure.

This polymerisable LC medium can be coated or printed onto the substrate, for example by spin-coating, printing, or other known techniques, and the solvent is evaporated off before polymerisation. In most cases, it is suitable to heat the mixture in order to facilitate the evaporation of the solvent.

The polymerisable LC medium can be applied onto a substrate by conventional coating techniques like spin coating, bar coating or blade coating. It can also be applied to the substrate by conventional printing techniques which are known to the expert, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

Suitable substrate mediums and substrates are known to the expert and described in the literature, as for example conventional substrates used in the optical films industry, such as glass or plastic. Especially suitable and preferred substrates for polymerisation are polyester such as polyethyleneterephthalate (PET) or polyethylenenaphthalate (PEN), polyvinylalcohol (PVA), polycarbonate (PC), triacetylcellulose (TAC), cyclo-olefin polymers (COP), or commonly known color filter materials, preferably triacetylcellulose (TAC), cyclo-olefin polymers (COP), or commonly known colour filter materials.

The Friedel-Creagh-Kmetz rule can be used to predict whether a mixture will adopt planar or homeotropic alignment, by comparing the surface energies of the RM layer (γ_{RM}) and the substrate (γₛ):
If γ_{RM}>γₛ the reactive mesogenic compounds will display homeotropic alignment, If γ_{RM}<γₛ the reactive mesogenic compounds will display homogeneous alignment.

Without to be bound by theory, when the surface energy of a substrate is relatively low, the intermolecular forces between the reactive mesogens are stronger than the forces across the RM-substrate interface and consequently, reactive mesogens align perpendicular to the substrate (homeotropic alignment) in order to maximise the intermolecular forces. Accordingly, an additional alignment layer capable of inducing a planar alignment to the adjacent polymerisable LC medium is required.

When the surface tension of the substrate is greater than the surface tension of the RMs, the force across the interface dominates. The interface energy is minimised if the reactive mesogens align parallel with the substrate, so the long axis of the RM can interact with the substrate. One way planar alignment can be promoted is by coating the substrate with a polyimide layer, and then rubbing the alignment layer with a velvet cloth. Other suitable planar alignment layers are known in the art, like for example rubbed polyimide or alignment layers prepared by photoalignment as described in U.S. Pat. Nos. 5,602,661, 5,389,698 or U.S. Pat. No. 6,717,644.

In general, reviews of alignment techniques are given for example by I. Sage in “Thermotropic Liquid Crystals”, edited by G. W. Gray, John Wiley & Sons, 1987, pages 75-77; and by T. Uchida and H. Seki in “Liquid Crystals—Applications and Uses Vol. 3”, edited by B. Bahadur, World Scientific Publishing, Singapore 1992, pages 1-63. A further review of alignment materials and techniques is given by J. Cognard, Mol. Cryst. Liq. Cryst. 78, Supplement 1 (1981), pages 1-77.

In a preferred embodiment, the process according to the invention contains a process step where the polymerisable LC medium is allowed to rest for a period of time in order to evenly redistribute the polymerisable LC medium on the substrate (herein referred to as “annealing”).

In a preferred embodiment, after providing the polymerisable LC medium onto the substrate, the layer stack is annealed for a time between 10 seconds and 1 hour, preferably between 20 seconds and 10 minutes and most preferably between 30 seconds and 2 minutes. The annealing is preferably performed at room temperature.

The polymerisable LC medium preferably consists of compounds that aling spontaneously when being deposited as a mixture onto the substrate. Therefore, preferably the LC medium is not subjected to heat treatment to align the mesogenic or liquid-crystalline compounds before the UV exposure.

If necessary, the layer stack can be cooled down to room temperature after annealing at an elevated temperature. The cooling can be performed actively with the help of cooling aids or passively just by letting the layer stack rest for a given time.

In a preferred embodiment, in the 1^{st} UV step the polymerisable LC medium is exposed to actinic radiation as described for example in WO 01/20394, GB 2,315,072 or WO 98/04651.

Actinic radiation means irradiation with light, like UV light, IR light or visible light, irradiation with X-rays or gamma rays, or irradiation with high-energy particles, such as ions or electrons. Preferably, the 1^{st} UV step is carried out by photo irradiation, in particular with UV light, especially with UVA light.

As a source for actinic radiation, for example a single UV lamp or a set of UV lamps can be used. When using a high lamp power the curing time can be reduced. Another possible source for photo radiation is a laser, like e.g. a UV laser, an IR laser, or a visible laser.

The curing time is dependent, inter alia, on the reactivity of the photoreactive compounds, the thickness of the coated layer, and the power and selected wavelength of the UV lamp. The curing time is preferably ≤5 minutes, very preferably ≤3 minutes, most preferably ≤1 minute. For mass production, short curing times of ≤30 seconds are preferred.

A suitable UV radiation power in the 1^{st} UV step is preferably in the range from 5 to 300 mWcm⁻², more preferably in the range from 50 to 250 mWcm⁻² and most preferably in the range from 100 to 180 mWcm⁻².

In connection with the applied UV radiation and as a function of time, a suitable UV dose is preferably in the range from 20 to 1000 mJcm⁻², more preferably in the range from 30 to 800 mJcm⁻², very preferably in the range from 40 to 500 mJcm⁻², most preferably in the range from 40 to 200 mJcm⁻².

The first irradiation step or 1^{st} UV step are preferably performed in air.

The first irradiation step or 1^{st} UV step are preferably performed at room temperature.

Photopolymerisation in the second irradiation step of the polymerisable LC medium is preferably achieved by exposing it to actinic radiation. Actinic radiation means irradiation with light, like UV light, IR light or visible light, irradiation with X-rays or gamma rays, or irradiation with high-energy particles, such as ions or electrons. Preferably, polymerisation is carried out by photo irradiation, in particular with UV light. As a source for actinic radiation, for example a single UV lamp or a set of UV lamps can be used. When using a high lamp power the curing time can be reduced. Another possible source for photo radiation is a laser, like e.g. a UV laser, an IR laser, or a visible laser.

The curing time for the photopolymerisation is dependent, inter alia, on the reactivity of the polymerisable LC medium, the thickness of the coated layer, the type of polymerisation initiator and the power of the UV lamp. The curing time is preferably ≤5 minutes, very preferably ≤3 minutes, most preferably ≤1 minute. For mass production, short curing times of ≤30 seconds are preferred.

A suitable UV radiation power for the photopolymerisation is preferably in the range from 100 to 1000 mWcm⁻², more preferably in the range from 200 to 800 mWcm⁻² and most preferably in the range from 300 to 600 mWcm⁻².

In connection with the applied UV radiation and as a function of time, a suitable UV dose is preferably in the range from 25 to 16500 mJcm⁻², more preferably in the range from 50 to 7200 mJcm⁻², very preferably in the range from 100 to 3500 mJcm⁻² and most preferably in the range from 200 to 2000 mJcm⁻².

Photopolymerisation (the second irradiation step or 2^{nd} UV step) is preferably performed under an inert gas atmosphere, preferably in a nitrogen atmosphere.

Photopolymerisation (the second irradiation step or 2^{nd} UV step) is preferably performed at room temperature.

The preferred thickness of a polymerised LC film according to the present invention is determined by the optical properties desired from the film or the final product.

For optical applications of the polymer film, it preferably has a thickness of from 0.5 to 10 μm, very preferably from 0.5 to 5 μm, in particular from 0.5 to 3 μm.

After photopolymerisation, the resulting polymer film can be removed from the substrate and combined with other substrates or optical films by a laminating process known by the skilled person. Suitable substrates and optical films are given above and include especially polarisers, in particulat linear polarisers.

Without to be bound to the theory the inventors believe, that the presence of oxygen in air during the 1^{st} UV step inhibits free-radical polymerisation. This effect is taken advantage of in order to partially polymerise the film with a gradient in the film depth. The top of the film which is exposed to oxygen has a low rate of polymerisation. The bottom of the film at the substrate interface is far less hindered by oxygen so polymerisation occurs more easily.

Due to the presence of at least one photoreactive chiral compound, photoisomerisation occurs during the 1^{st}UV step and helical twist power (HTP) of the photoreactive chiral compound is reduced when being exposed to the UV light. The change in chiral structure is physically resisted in areas of higher polymer density. At the top or surface of the film the polymer density is low so the chiral structure can be modified more freely. However, at the bottom of the film adjacent to the substrate, where more photopolymerisation occurs, the polymer density is higher so the change in chiral structure is impeded. This leads to a chiral pitch gradient present in the film. Accordingly, after performing the method as described above, the polymerised LC medium exhibits an accelerated chiral rotation in direction to the main plane of the polymer film or the film thickness. Preferably the polymerised LC medium exhibits a biased pitch, such that the chiral rotation angle increases or decreases incrementally through the film thickness.

In the polymer film according to the present invention, preferably the minimum twist angle is 0°. Further preferably the maximum twist angle is in the range from 70 to 150°, very preferably from 80 to 120°, most preferably from 90 to 110°. Preferably the twist angle varies from 0° to 150°, very preferably from 0° to 120°, most preferably from 0° to 100° in the direction of the film thickness. Preferably the lower twist value is at the side of the polymer film adjacent to the substrate on which it is prepared. The average twist angle in the polymer film is preferably in the range from 10 to 40°, very preferably from 15 to 35°, most preferably from 20 to 30°.

Preferably the polymer film according to the present invention has negative optical dispersion. Preferably the polymer film according to the present invention has an optical retardation in the range from 110 nm to 170 nm, very preferably from 130 nm to 150 nm, at 550 nm; and also 90 nm to 140 nm, very preferably from 110 nm to 120 nm, at 450 nm.

In summary, the polymerised LC films and polymerisable LC mediums according to the present invention are useful for optical components or elements.

The polymerised LC films and polymerisable LC mediums according to the present invention can be used in displays of the transmissive or reflective type, especially they can be used in conventional OLED displays or LCDs, in particular OLED displays.

The present invention is described above and below with particular reference to the preferred embodiments. It should be understood that various changes and modifications might be made therein without departing from the spirit and scope of the invention.

Many of the compounds or mixtures thereof mentioned above and below are commercially available. All of these compounds are either known or can be prepared by methods which are known per se, as described in the literature (for example in the standard works such as Houben-Weyl, Methoden der Organischen Chemie [Methods of Organic Chemistry], Georg-Thieme-Verlag, Stuttgart), to be precise under reaction conditions which are known and suitable for said reactions. Use may also be made here of variants which are known per se, but are not mentioned here.

It will be appreciated that variations to the foregoing embodiments of the invention can be made while still falling within the scope of the invention. Alternative features serving the same, equivalent, or similar purpose may replace each feature disclosed in this specification, unless stated otherwise. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

The invention will now be described in more detail by reference to the following working examples, which are illustrative only and do not limit the scope of the invention.

### Example 1

The mixture RMM1 is prepared in accordance with the following table:

| RMM 1 | Conc.in |
|---|---|
| Compound | % w/w |
| 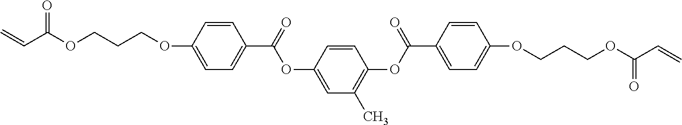 [SMILES: C=CC(=O)OCCCOc1ccc(C(=O)Oc2ccc(OC(=O)c3ccc(OCCCOC(=O)C=C)cc3)c(C)c2)cc1] | 42.92 |
| RM-A | |
| 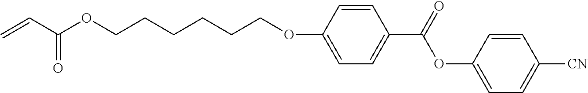 [SMILES: C=CC(=O)OCCCCCCOc1ccc(C(=O)Oc2ccc(C#N)cc2)cc1] | 28.96 |
| RM-B | |
| 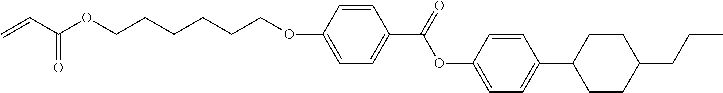 [SMILES: C=CC(=O)OCCCCCCOc1ccc(C(=O)Oc2ccc(C3CCC(CCC)CC3)cc2)cc1] | 15.13 |
| RM-C | |
| 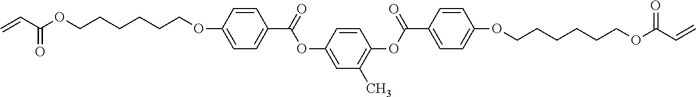 [SMILES: C=CC(=O)OCCCCCCOc1ccc(C(=O)Oc2ccc(OC(=O)c3ccc(OCCCCCCOC(=O)C=C)cc3)c(C)c2)cc1] | 10.72 |
| RM-D | |
| 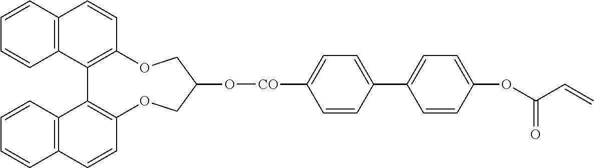 [SMILES: C=CC(=O)Oc1ccc(-c2ccc(C(=O)OC3COc4ccc5ccccc5c4-c4c(ccc5ccccc45)OC3)cc2)cc1] | 0.29 |
| (S)-Configuration | |
| CD-1 | |
| 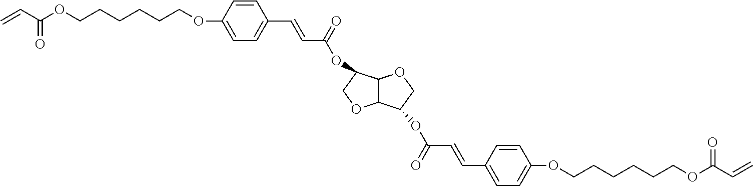 [SMILES: C=CC(=O)OCCCCCCOc1ccc(/C=C/C(=O)O[C@H]2COC3C2OC[C@H]3OC(=O)/C=C/c2ccc(OCCCCCCOC(=O)C=C)cc2)cc1] | 0.45 |
| (R)-Configuration | |
| CD-2 | |
| NCI®-930 (Photoinitiator) | 0.60 |
| BYK®-310 (Surfactant) | 0.85 |
| Irganox®1076 (Stabilizer) | 0.08 |

Irganox®1076 is a stabilizer, being commercially available (Ciba AG, Basel, Switzerland). NCI®-930 is a photoinitiator, being commercially available (Adeka Coorporation, Japan). BYK®-310 is a surfactant being commercially available (BYK, Germany).

### Polymer Film Forming Process

The mixture RMM-1 is transformed to a formulation by dissolving in a solvent blend of toluene:
cyclohexanone (7:3) at a ratio of 36% solids to 64% solvent by mass. Nissan PAL HSPA-152 is barcoated with MB #3 bar on onto 60 μm TAC substrate. The substrate is then baked at 110° C. for 60 seconds and exposed with polarised with the use of a wire grid polariser using a high pressure mercury lamp (LH6 fusion) 67 mW/cm² and 12 mJ/cm², UVA. The formulation is barcoated onto the alignment layer obtained from Nissan PAL HSPA-152 using MB #6 annealed at 60° C. for 60 seconds, followed by an exposure UV light utilizing high pressure mercury lamp (LH6 fusion), 180 mW/cm² and 40 mJ/cm² UVA. After the first UV step, the sample is purged with nitrogen for 60 seconds and finally exposed to UV light utilizing a high pressure mercury lamp (LH6 fusion), 520 mW/cm² and 220 mJ/cm² UVA.

### Optical Results

The polymer film is measured with an Axometrics Axostep and each polymer film is measured twice, once film up (Light source, Substrate, Polymer Film Detector) eand once film down (Light source, Polymer Film, Substrate, Detector). The spectral polarisation states are plotted on Poincare spheres The polarisation ellipse varies for each wavelength, but each has left-handed rotation. Due to the asymmetry of the twist in the z direction the film does not act reversibly.

To produce an achromatic circular polariser the rear of the polymer film (the side with lower twist) is laminated with a linear polariser, whereby the polariser transmission axis is at 45° to the initial director of the aligned LC medium.

When light enters through the bottom of the polymer film it travels first through the area of low twist. In this configuration the horizontal linearly polarised input light is transformed to right handed circularly polarised (RHCP) light and occurs equally efficiently for all visible wavelengths.

When light enterers through the top of the polymer film it travels first through the area of high twist. In this configuration the right handed circularly polarised input light is transformed to horizontal linearly polarised light and occurs equally efficiently for all visible wavelengths.

Raytracing is used to simulate the output polarisation state for a chosen input polarisation state. In the film up measurement raytracing shows how horizontal input light is converted to RHCP output.and that all spectral polarisation states are closely grouped on the +S3 pole of Poincare sphere (S=[1,0,0,1]). In the film down measurement raytracing shows that RHCP input light is converted to horizontal linearly polarised output and that spectral polarisation states are closely grouped on the +S1 (S=[1,1,0,0] pole of Poincare sphere.

The Mueller matrix data measured with the Axometrics Axoscan has been used to model the progression of the director orientation through the film. The accelerating twist profile is shown in FIG. 2.

### Anti-Reflection Visual Performance

An anti-reflection stack S1 is created by arranging the polymer film of Example 1 between a reflective surface, such as a metallic cathode of an OLED display, and a linear polariser.

For comparison, reference anti-reflection stacks R1 and R2 are created as described above, but wherein in reference stack R1 the polymer film of Example 1 is replaced by a polymer film with quarter wave retardation and negative dispersion made from a H-shape compound, and in reference stack R2 the polymer film of Example 1 is replaced by a polymer film with quarter wave retardation but positive dispersion.

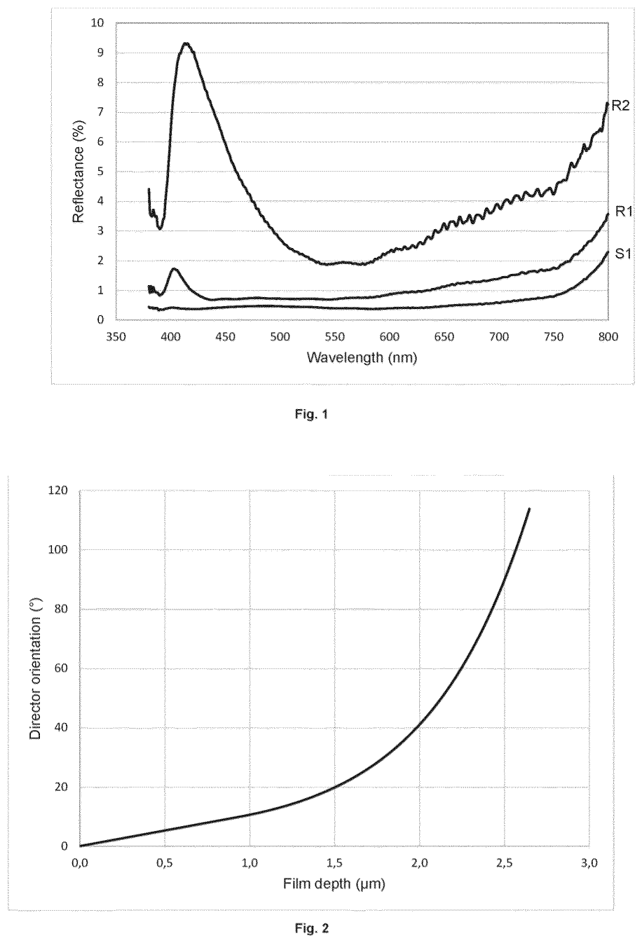

The anti-reflection performance of the three stacks is measured with the use of a DMS and is shown in FIG. 1. It can be seen that stack S1 comprising the polymer film of Example 1 shows the lowest reflectance, compared to the reference stacks R1 and R2.

### Example 2

The mixtures RMM2 to RMM7 are prepared in accordance with the table below:

| | Concentration in % w/w | | | | | |
|---|---|---|---|---|---|---|
| Compound | RMM2 | RMM3 | RMM4 | RMM5 | RMM6 | RMM7 |
| RM-A | 42.89 | 42.89 | 42.92 | 42.87 | 42.54 | 42.26 |
| RM-B | 28.94 | 28.94 | 28.95 | 28.93 | 28.70 | 28.51 |
| RM-C | 15.12 | 15.12 | 15.12 | 15.12 | 15.00 | 14.90 |
| RM-D | 10.72 | 10.72 | 10.73 | 10.71 | 10.63 | 10.56 |
| CD-1 | 0.33 | 0.33 | 0.29 | 0.33 | 0.33 | 0.33 |
| CD-2 | 0.51 | 0.51 | 0.46 | 0.51 | 0.51 | 0.51 |
| BYK ®-310 | 0.85 | 0.85 | 0.85 | 0.85 | 0.85 | 0.85 |
| (Surfactant) | | | | | | |
| Irganox ®1076 | 0.08 | 0.08 | 0.08 | 0.08 | 0.08 | 0.08 |
| (Stabilizer) | | | | | | |
| SPI03 | 0.56 | — | — | — | — | — |
| (Photoinitiator) | | | | | | |
| TR-PBG-304 | — | 0.56 | — | — | — | — |
| (Photoinitiator) | | | | | | |
| NCI-930 | — | — | 0.60 | 0.60 | — | — |
| (Photoinitiator) | | | | | | |
| N1919-T | — | — | — | — | 1.36 | — |
| (Photoinitiator) | | | | | | |
| Irgacure ® 651 | — | — | — | — | — | 2.00 |
| (Photoinitiator) | | | | | | |

SPI03 is a photoinitiator, being commercially available (Samyang, Korea) TR-PBG-304 is a photoinitiator, being commercially available (Tronly, China) N1919-T is a photoinitiator, being commercially available (Adeka Cooperation, Japan) Irgacure®651 is a photoinitiator, being commercially available (Ciba AG, Basel, Switzerland).

Polymer films are prepared from each of RMM2 to RMM7 and the optical results measured as described in Example 1. All polymer films show the desired chiral structure and have similar optics when measured on the Axoscan.

This shows that the type of the photoinitiator is not critical for the mechanism to produce the desired chiral structure and a broad variety of photoinitiators can be used.

1. A polymerisable LC medium comprising one or more di- or multireactive mesogenic compounds, one or more chiral compounds with (S)-configuration, and additionally one or more chiral compounds with (R)-configuration, wherein at least one of said chiral compounds either in (S) configuration or in (R) configuration is selected from photoreactive chiral compounds.

2. The polymerisable LC medium according to claim 1, wherein at least one of said chiral compounds either in (S) configuration or in (R) configuration is selected from polymerisable photoreactive chiral compounds.

3. The polymerisable LC medium according to claim 1, wherein the IHTP_{D} I of the medium is in the range from 0.1 μm⁻¹ to 100 μm⁻¹.

4. The polymerisable LC medium according to claim 1, further comprising a photoinitiator.

5. The polymerisable LC medium according to claim 4, wherein the ratio of the concentration of the photoinitiator to the concentration of all chiral compounds as a whole is in the range from 1:1 to 1:5.

6. The polymerisable LC medium according to claim 1, wherein one or more di- or multireactive mesogenic compounds are selected of formula DRM 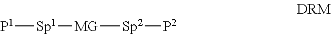
wherein
P¹ and P² independently of each other denote a polymerisable group,
Sp¹ and Sp² independently of each other are a spacer group or a single bond, and
MG is a rod-shaped mesogenic group, which is selected of formula MG 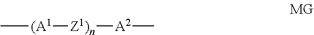
wherein
A¹ and A² denote, in case of multiple occurrence independently of one another, an aromatic or alicyclic group, which optionally contains one or more heteroatoms selected from N, O and S, and is optionally mono- or polysubstituted by L,
L is P-Sp-, F, Cl, Br, I, —CN, —NO₂, —NCO, —NCS, —OCN, —SCN, —C(═O)NR^{x}R^{y}, —C(═O)OR^{x}, —C(═O)R^{x}, —NR^{x}R^{y}, —OH, —SF₅, optionally substituted silyl, aryl or heteroaryl with 1 to 12, and straight chain alkyl, alkoxy, alkylcarbonyl, alkoxycarbonyl, alkylcarbonyloxy or alkoxycarbonyloxy with 1 to 12 C atoms or branched alkyl, alkoxy, alkylcarbonyl, alkoxycarbonyl, alkylcarbonyloxy or alkoxycarbonyloxy with 3 to 12 C atoms, wherein one or more H atoms are optionally replaced by F or Cl,
R^{x} and R^{y} independently of each other denote H or alkyl with 1 to 12 C-atoms,
Z¹ denotes, in case of multiple occurrence independently of one another, —O—, —S—, —CO—, —COO—, —OCO—, —S—CO—, —CO—S—, —O—COO—, —CO—NR^{x}—, —NR^{x}—CO—, —NR^{x}—CO—NR^{y}, —NR^{x}—CO—O—, —O—CO—NR^{x}—, —OCH₂—, —CH₂O—, —SCH₂—, —CH₂S—, —CF₂O—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR^{x}—, —CY¹═CY²—, —C≡C—, —CH═CH—COO—, —OCO—CH═CH— or a single bond, pr,
Y¹ and Y² independently of each other denote H, F, Cl or CN,
n is 1, 2, 3 or 4,
n1 is an integer from 1 to 10.

7. The polymerisable LC medium according to claim 1, wherein the concentration of di- or multireactive mesogenic compounds is from 5 to 70%.

8. The polymerisable LC medium according to claim 1, comprising one or more monoreactive mesogenic compounds, selected from compounds of formula MRM: 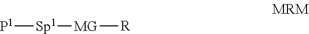
wherein
P¹ denotes a polymerisable group,
Sp¹ denotes a spacer group or a single bond, and
MG is a rod-shaped mesogenic group, which is selected of formula MG 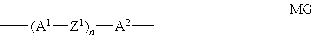
wherein
A¹ and A² denote, in case of multiple occurrence independently of one another, an aromatic or alicyclic group, which optionally contains one or more heteroatoms selected from N, O and S, and is optionally mono- or polysubstituted by L,
L is P-Sp-, F, Cl, Br, I, —CN, —NO₂, —NCO, —NCS, —OCN, —SCN, —C(═O)NR^{x}R^{y}, —C(═O)OR^{x}, —C(═O)R^{x}, —NR^{x}R^{y}, —OH, —SF₅, optionally substituted silyl, aryl or heteroaryl with 1 to 12, and straight chain alkyl, alkoxy, alkylcarbonyl, alkoxycarbonyl, alkylcarbonyloxy or alkoxycarbonyloxy with 1 to 12 C atoms or branched alkyl, alkoxy, alkylcarbonyl, alkoxycarbonyl, alkylcarbonyloxy or alkoxycarbonyloxy with 3 to 12 C atoms, wherein one or more H atoms are optionally replaced by F or Cl,
Z¹ denotes, in case of multiple occurrence independently of one another, —O—, —S—, —CO—, —COO—, —OCO—, —S—CO—, —CO—S—, —O—COO—, —CO—NR^{x}—, —NR^{x}—CO—, —NR^{x}—CO—NR^{y}, —NR^{x}—CO—O—, —O—CO—NR^{x}—, —OCH₂—, —CH₂O—, —SCH₂—, —CH₂S—, —CF₂O—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR^{x}—, —CY¹═CY²—, —C≡C—, —CH═CH—COO—, —OCO—CH═CH— or a single bond,
Y¹ and Y² independently of each other denote H, F, Cl or CN,
n is 1, 2, 3 or 4,
n1 is an integer from 1 to 10,
R denotes P-Sp-, F, Cl, Br, I, —CN, —NO₂, —NCO, —NCS, —OCN, —SCN, —C(═O)NR^{x}R^{y}, —C(═O)X, —C(═O)OR^{x}, —C(═O)R^{y}, —NR^{x}R^{y}, —OH, —SF₅, optionally substituted silyl, straight chain or branched alkyl, alkoxy, alkylcarbonyl, alkoxycarbonyl, alkylcarbonyloxy or alkoxycarbonyloxy with 1 to 12 C atoms or branched alkyl, alkoxy, alkylcarbonyl, alkoxycarbonyl, alkylcarbonyloxy or alkoxycarbonyloxy with 3 to 12 C atoms, wherein one or more H atoms are optionally replaced by F or Cl,
X is halogen, and
R^{x} and R^{y} are independently of each other H or alkyl with 1 to 12 C— atoms.

9. The polymerisable LC medium according to claim 1, wherein the photoreactive chiral compounds are selected from polymerisable photoreactive chiral compounds of formula I: 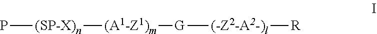
wherein
P is CH₂═CW—COO—, WCH═CH—O—, or CH₂═CH-Phenyl-(O)ₖ— with W being H, CH₃ or F, Cl and k being 0 or 1,
Sp is a spacer group having 1 to 20 C atoms,
X is a group selected from —O—, —S—, —CO—, —COO—, —OCO—, —OCO—O—, —S—CO—, —CO—S— or a single bond,
n is 0 or 1,
Z¹ and Z² are each independently —COO—, —OCO—, —CH₂CH₂—, —OCH₂—, —CH₂O—, —CH═CH—, —CH═CH—COO—, —OCO—CH═CH—, —C≡C—, or a single bond,
A¹ and A² are each independently 1,4-phenylene in which, in addition, one or more CH groups may be replaced by N, 1,4-cyclohexylene in which, in addition, one or two non-adjacent CH₂ groups may be replaced by O and/or S, 1,4-cyclohexenylene, 1,4-bicyclo(2,2,2)octylene, piperidine-1,4-diyl, naphthalene-2,6-diyl, decahydronaphthalene-2,6-diyl, or 1,2,3,4-tetrahydro-naphthalene-2,6-diyl, it being possible for all these groups to be unsubstituted, mono- or polysubstituted with halogen, cyano or nitro groups or alkyl, alkoxy or acyl groups having 1 to 7 C atoms wherein one or more H atoms may be substituted by F or Cl,
m and l are each independently 0, 1 or 2,
G is the following structure element 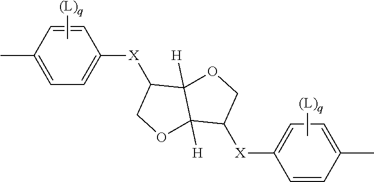
with q being 0, 1, 2, 3 or 4 and L being in each case independently halogen, a cyano or nitro group or an alkyl, alkoxy or acyl group having 1 to 7 C atoms wherein one or more H atoms may be substituted by F or Cl, x being photoreactive group, and
R is an alkyl radical with up to 25 C atoms which may be unsubstituted, mono- or polysubstituted by halogen or CN, it being also possible for one or more non-adjacent CH₂ groups to be replaced, in each case independently from one another, by —O—, —S—, —NH—, —N(CH₃)—, —CO—, —COO— —OCO—, —OCO—O—, —S—CO—, —CO—S— or —C≡C— in such a manner that oxygen atoms are not linked directly to one another, or alternatively R is halogen, cyano or has independently one of the meanings given for P-(Sp-X)ₙ—.

10. The polymerisable LC medium according to claim 1, wherein the photoreactive chiral compounds are selected from polymerisable photoreactive chiral compounds of formula Ia: 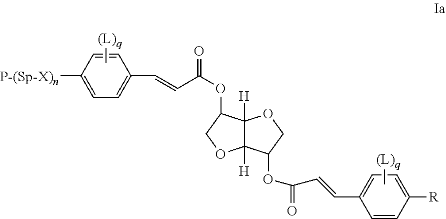
wherein
P is CH₂═CW—COO—, WCH═CH—O—, or CH₂═CH-Phenyl-(O)ₖ— with W being H, CH₃ or F, C₁ and k being 0 or 1,
Sp is a spacer group having 1 to 20 C atoms,
X is a group selected from —O—, —S—, —CO—, —COO—, —OCO—, —OCO—O—, —S—CO—, —CO—S— or a single bond,
n is 0 or 1,
L being in each case independently halogen, a cyano or nitro group or an alkyl, alkoxy or acyl group having 1 to 7 C atoms wherein one or more H atoms may be substituted by F or Cl, x being photoreactive group,
q being 0, 1, 2, 3 or 4, and
R is an alkyl radical with up to 25 C atoms which may be unsubstituted, mono- or polysubstituted by halogen or CN, it being also possible for one or more non-adjacent CH₂ groups to be replaced, in each case independently from one another, by —O—, —S—, —NH—, —N(CH₃)—, —CO—, —COO— —OCO—, —OCO—O—, —S—CO—, —CO—S— or —C≡C— in such a manner that oxygen atoms are not linked directly to one another, or alternatively R is halogen, cyano or has independently one of the meanings given for P-(Sp-X)ₙ—.

11. The polymerisable LC medium according claim 1, comprising one or more monoreactive mesogenic compounds in a concentration from 1 to 80%.

12. A process for the production of a polymerisable LC medium according to claim 1, comprising at least the steps of mixing one or more di- or multireactive mesogenic compounds, with one or more chiral compounds with (S)-configuration, and one or more chiral compounds with (R)-configuration, wherein at least one of the chiral compounds comprises an photoisomerisable group.

13. A method of producing a polymer film exhibiting a biased pitch, wherein the chiral rotation angle increases or decreases incrementally through the film thickness, using a polymerisable LC medium according claim 1.

14. A process of preparing a polymer film comprising the steps of
providing a layer of a polymerisable LC medium according to claim 1 onto a substrate, which is optionally provided with an alignment layer capable of inducing a planar alignment to the adjacent layer of the polymerisable LC medium,
a first step of irradiation of the layer stack with actinic radiation in air, and
a second step of irradiation of the layer stack with actinic radiation in an inert gas atmosphere.

15. The process of claim 14, wherein the first and second steps of irradiation with actinic radiation are carried out by exposure to UV radiation.

16. The process of claim 14, wherein the first and second steps of irradiation or UV exposure are carried out at room temperature, and the layer of the polymerisable LC medium is not subjected to heat treatment during or between the first and second steps of irradiation or UV exposure.

17. A polymer film obtained by the process according to claim 14.

18. The polymer film according to claim 17, wherein it exhibits a biased pitch wherein the chiral rotation angle increases or decreases incrementally through the film thickness.

19. An optical component comprising the polymer film according to claim 17.

20. A method for the production of an optical component comprising the step of laminating a polymer film according to claim 17 onto a substrate or another polymer film.

21. An optical component comprising a polymer film according to claim 18.

22. The optical component according to claim 21, wherein it further comprises a +A plate.

23. The optical component according to claim 21, comprising a QWP or an antireflective component.

24. An optical or an electrooptical device comprising the polymer film according to claim 17.

25. An optical or electrooptical device comprising the optical component according to claim 21.
